(19) United States
(12) Patent Application Publication
(10) Pub. No.: US 2026/0264797 A1
(43) Pub. Date: Sep. 10, 2026

(54) STEERING DEVICE FOR A BICYCLE

(71) Applicant: SRAM, LLC, CHICAGO, IL (US)

(72) Inventors: CHARLES DUNLAP, MANITOU SRPINGS, CO (US); BRIAN JORDAN, CHICAGO, IL (US); KEVIN WESLING, LOMBARD, IL (US)

(73) Assignee: SRAM, LLC, CHICAGO, IL (US)

(21) Appl. No.: 19/554,184

(22) Filed: Mar. 2, 2026

Related U.S. Application Data
(60) Provisional application No. 63/769,146, filed on Mar. 9, 2025.

(51) Int. Cl. B62K 21/12; B62K 21/04; B62K 21/06; B62K 21/18

(52) U.S. Cl. CPC B62K 21/12; B62K 21/04; B62K 21/06; B62K 21/18

(57) ABSTRACT

A steering device for a bicycle may be provided to control directional travel of the bicycle. The steering device may include a stem for attachment between a handlebar and a steerer. The stem may include a first steerer clamp for attachment to the steerer between a first bearing and a second bearing and a second steerer clamp for attachment to the steerer above the first bearing and the second bearing. The stem may further include a handlebar clamp for attachment to the handlebar.

### CROSS REFERENCE TO RELATED APPLICATION

This application claims the benefit of U.S. Provisional Patent Application 63/769,146, filed Mar. 9, 2025, which is hereby incorporated by reference in its entirety.

### FIELD

The present disclosure relates to bicycle components, and more specifically to handlebar, stem, and steering arrangements.

### BACKGROUND

Bicycles generally have steering components. Steering components include handlebars, stems, head tubes, bearings, seals, and the like. Positioning of steering components is important for bicycle control and rider fit. To accommodate ergonomic rider control for various bicycle and rider sizes, steering components may be provided. Bicycles with large wheel sizes may generally be difficult to accommodate certain riders with conventional steering components.

As such, there is a need for steering components that accommodate riders across a broader range of bicycle and wheel sizes.

### SUMMARY

An object of this disclosure is to describe various steering components for bicycles. Steering components may be generally configured to accommodate riders of different sizes. For example, steering components may be provided to accommodate relatively small riders on relatively large bicycles. Relatively large bicycles may be desired for riders to accommodate larger wheel sizes. For example, riders may wish to take advantage of lower rolling resistance provided by larger wheel and tire sizes, especially over rough terrain.

### BRIEF DESCRIPTION OF THE DRAWINGS

FIG. 1 is a side view of an example bicycle that can employ any of the steering devices described herein.

FIG. 2A is a perspective view of an example steering device mounted to a bicycle.

FIG. 2B is a reversed perspective view of the example steering device of FIG. 2A.

FIG. 3A is an upper perspective view of the example steering device of FIG. 2A.

FIG. 3B is a side view of the example steering device of FIG. 2A.

FIG. 4A is a front view of the example steering device of FIG. 2A.

FIG. 4B is a top view of the example steering device of FIG. 2A.

FIG. 5 is a sectional view of the example steering device of FIG. 2A, taken along line 5-5 in FIG. 4B.

FIG. 6 is a sectional view of another example steering device in a first position.

FIG. 7 is a sectional view of the example steering device of FIG. 6 in a second position.

FIG. 8 is a sectional view of yet another example steering device.

FIG. 9 is a sectional view of yet another example steering device.

FIG. 10 is a sectional view of yet another example steering device.

FIG. 11 is an exploded view of the example steering device of FIG. 2A.

FIG. 12A is a partial side view of a frame of the bicycle as shown in FIG. 2A.

FIG. 12B is a front view of the frame shown in FIG. 12A.

FIG. 13 is a sectional view of the frame shown in FIG. 12A taken along line 13-13 in FIG. 12B.

FIG. 14A is a perspective view of a steerer as shown in the exploded view of FIG. 11.

FIG. 14B is a side view of the steerer of FIG. 14A.

FIG. 15 is a sectional view of the steerer of FIG. 14A, taken along line 15-15 in FIG. 14B.

FIG. 16A is a perspective view of a stem as shown in FIG. 2A.

FIG. 16B is a top view of the stem of FIG. 16A.

FIG. 17A is a side view of the stem of FIG. 16A.

FIG. 17B is a sectional view of the stem of FIG. 16A, taken along line 17-17 in FIG. 17A.

FIG. 18A is a perspective view of another stem that may be used with various bicycles as shown in the sectional views of FIGS. 6 and 7.

FIG. 18B is a top view of the stem of FIG. 18A.

FIG. 19A is a side view of the stem of FIG. 18A.

FIG. 19B is a sectional view of the stem of FIG. 18A, taken along line 19-19 in FIG. 19A.

FIG. 20A is a perspective view of yet another stem that may be used with various bicycles as shown in the sectional view of FIG. 8.

FIG. 20B is a top view of the stem of FIG. 20A.

FIG. 21A is a side view of the stem of FIG. 20A.

FIG. 21B is a sectional view of the stem of FIG. 20A, taken along line 21-21 in FIG. 21A.

FIG. 22A is a perspective view of a shield element as shown in the exploded view of FIG. 11.

FIG. 22B is a top view of the shield element of FIG. 22A.

FIG. 23A is a side view of the shield element of FIG. 22A.

FIG. 23B is a sectional view of the shield element of FIG. 22A, taken along line 23-23 in FIG. 23A.

FIG. 23C is an enlarged view of the sectional view of FIG. 23B.

FIG. 24A is a perspective view of a seal element as shown in the exploded view of FIG. 11.

FIG. 24B is a top view of the seal element of FIG. 24A.

FIG. 25A is a sectional view of the seal element of FIG. 24A, taken along line 25-25 in FIG. 24B.

FIG. 25B is an enlarged view of the sectional view of FIG. 25A.

FIG. 26A is a perspective view of another example steering device mounted to a bicycle.

FIG. 26B is a reversed perspective view of the example steering device of FIG. 26A.

FIG. 27A is a side view of a steering stop element shown with the example steering device of FIG. 26A.

FIG. 27B is a front view of the steering stop element of FIG. 27A.

FIG. 28A is a top view of the example steering device of FIG. 26A in a stop position.

FIG. 28B is a front perspective view of the example steering device of FIG. 26A in the stop position of FIG. 28A.

FIG. 29A is a sectional view of the example steering device of FIG. 26A, taken along line 29-29 in FIG. 28B.

FIG. 29B is an enlarged view of the sectional view of FIG. 29A.

FIG. 30A is a perspective view of yet another example steering device mounted to a bicycle.

FIG. 30B is a front view of the example steering device of FIG. 30A.

FIG. 31A is a perspective view of a guide element that may be used with an example steerer device.

FIG. 31B is a top view of the guide element of FIG. 31A.

FIG. 31C is a sectional view of the guide element of FIG. 31A, taken along line 31-31 in FIG. 31B.

FIG. 32A is a perspective view of a guide element that may be used with an example steerer device.

FIG. 32B is a top view of the guide element of FIG. 32A.

FIG. 32C is a sectional view of the guide element of FIG. 32A, taken along line 32-32 in FIG. 32B.

FIG. 33A is a perspective view of a guide element that may be used with an example steerer device.

FIG. 33B is a top view of the guide element of FIG. 33A.

FIG. 33C is a sectional view of the guide element of FIG. 33A, taken along line 33-33 in FIG. 33B.

The figures may not be to scale. Instead, the thickness of the layers or regions may be enlarged in the drawings. In general, the same reference numbers will be used throughout the drawing(s) and accompanying written description to refer to the same or like parts.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

The descriptors used herein, including the terms “first”, “second”, “third”, etc. may be used interchangeably to distinguish one component from another and are not intended to signify location or importance of the individual components. Unless otherwise specified or understood based on their context of use, such descriptors are not intended to impute any meaning of priority or ordering in time but merely as labels for referring to multiple elements or components separately for ease of understanding the disclosed examples. In some examples, the descriptor "first" may be used to refer to an element in the detailed description, while the same element may be referred to in a claim with a different descriptor such as "second" or "third." In such instances, it should be understood that such descriptors are used merely for ease of referencing multiple elements or components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various steering components may be provided with reference to the following disclosure. For example, front suspension forks, front rigid forks, stems, bearings, seals, handlebars, and more are contemplated in connection with the features that follow. Steering components on a bicycle may employ one or more features to provide ergonomic control and fitment to a rider. Disclosed herein are example steering components to achieve goals of ensuring rider fitment and ergonomics.

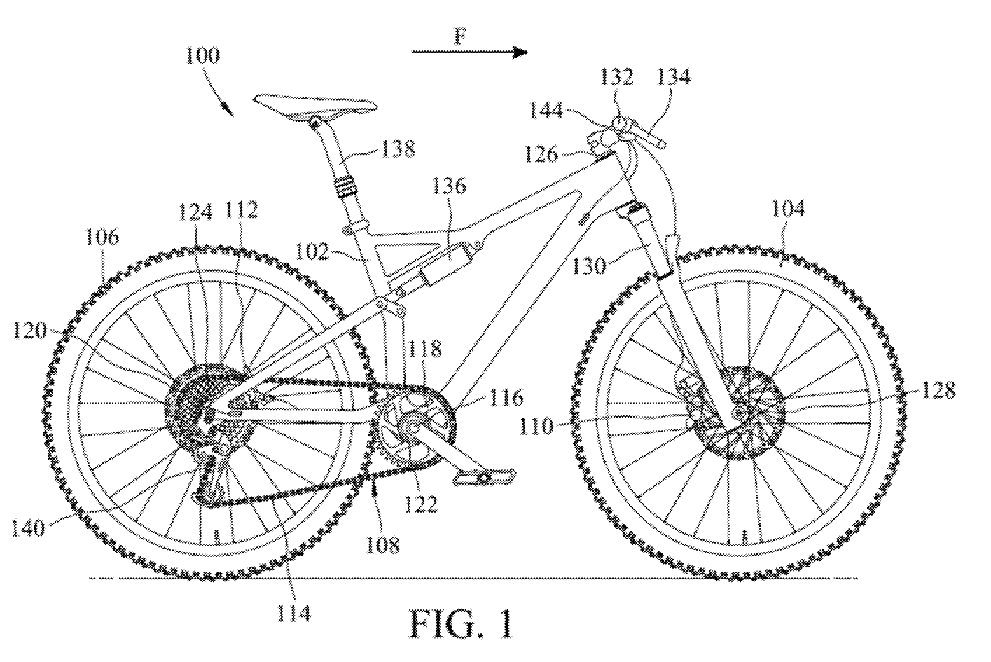

Turning now to the figures, FIG. 1 illustrates one example of a human powered vehicle on which the example steering components disclosed herein may be implemented. In this example, the vehicle is one possible type of bicycle 100, such as a mountain bicycle. However, it should be appreciated that example two-wheel vehicles of various types, for example road bicycles, gravel bicycles, electric bicycles, cargo bicycles, or motorcycles, may implement steering components as disclosed herein. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 130. A front and/or forward riding direction or orientation of the bicycle 100 is indicated by the direction of the arrow F in FIG. 1. As such, a forward direction of movement for the bicycle 100 is indicated by the direction of arrow F.

In the illustrated example of FIG. 1, the front wheel 104 and the rear wheel 106 are rotatably connected to the frame 102. In the illustrated example, the bicycle 100 further includes a braking system that includes a front brake 110 and a rear brake 112 for respectively braking the front wheel 104 and the rear wheel 106. In the illustrated example, a drivetrain 108 includes a chain 114, a crank assembly 116 rotatably mounted to the frame 102, a front sprocket assembly 118 coaxially mounted to the crank assembly 116, and a rear sprocket assembly 120 coaxially mounted to the rear wheel 106. Each of the front sprocket assembly 118 and the rear sprocket assembly 120 includes at least one sprocket.

In the illustrated example, the bicycle 100 includes a bottom bracket 122, a rear wheel hub 124, a headset 126, and a front wheel hub 128. The bottom bracket 122 is mounted to a bottom portion of the frame 102 and supports the crank assembly 116 relative to the frame 102. The rear wheel hub 124 is mounted to a rear portion of the frame 102 and supports the rear wheel 106 and the rear sprocket assembly 120 relative to the frame 102. The headset 126 is mounted to a front portion of the frame 102. In the illustrated example, the front wheel 104 is coupled to the front portion of the frame 102 via the front fork 130 that is rotatably mounted to the frame 102 with the headset 126. The front wheel hub 128 is mounted to a lower portion of the front fork 130 and supports the front wheel 104 relative to the front fork 130. The bicycle 100 may further have a handlebar 132 that is connected to and rotatable with the front fork 130. In some examples, the front fork 130 may be configured as a suspension fork. In some examples, the bicycle 100 may have a rear shock absorber 136 and/or a dropper seat post 138.

In the illustrated example of FIG. 1, the bicycle 100 may have a single-speed drivetrain or a multi-speed drivetrain which has a shifting system. For example, the bicycle 100 may have a multiple-geared drivetrain 108 that may have one or both of a front gear changer and a rear gear changer mounted to the frame 102. The gear changers may be mechanical or electromechanical derailleurs, internal gear systems, for example front gearboxes and/or rear internal gear hubs including planetary gearing. The illustrated example includes a rear derailleur 140 without a front shifting system, but it should be appreciated that any combination of gear changers is contemplated. The gear changers can be operated using one or more gear shifters 144, which may be mounted to the handlebar 132. The gear shifters 144 may operate the gear changers through wired or wireless signal communication, or via a physical connection using a mechanical shift cable or hydraulic line. The bicycle 100 as described above and shown in FIG. 1 is a full-suspension mountain bike with a flat handlebar. It should be appreciated that the type and style of bicycle may vary from the disclosed example. For example, a road bicycle with drop-style handlebars, along with a drivetrain having road type gearing with a road gear range may be used instead of a mountain bike or other bicycle gear range. Additionally, it should be appreciated that, as in an e-bike implementation, the bicycle 100 may be provided with an integrated electric motor used to assist propulsion.

In this example, the bicycle 100 includes brake system. The brake system includes at least one brake lever 134 that is movably connected to the handlebar 132. The brake lever 134 is configured to operate components of the brake system of the bicycle 100. In one example, the brake system can include one or both of a hydraulic or cable actuated front brake mechanism coupled to the front wheel 104 via a hydraulic line or mechanical cable and a hydraulic or cable actuated rear brake mechanism coupled to the rear wheel 106 through a hydraulic line or mechanical cable. As noted above, the brake system can be a hydraulically actuated system or a mechanically actuated system.

While the example bicycle 100 depicted in FIG. 1 is a type of mountain bicycle, the example front forks (and/or lower housings or housings) disclosed herein can be implemented on other types of bicycles. For example, the disclosed front forks may be used on road bicycles, as well as bicycles with mechanical (e.g., cable, hydraulic, pneumatic, etc.) and non-mechanical (e.g., wired, wireless) drive systems. The disclosed front forks can also be implemented on other types of two-wheeled, three-wheeled, and four-wheeled human powered vehicles. Further, the example front forks can be used on other types of vehicles, such as motorized vehicles (e.g., a motorcycle, a car, a truck, etc.).

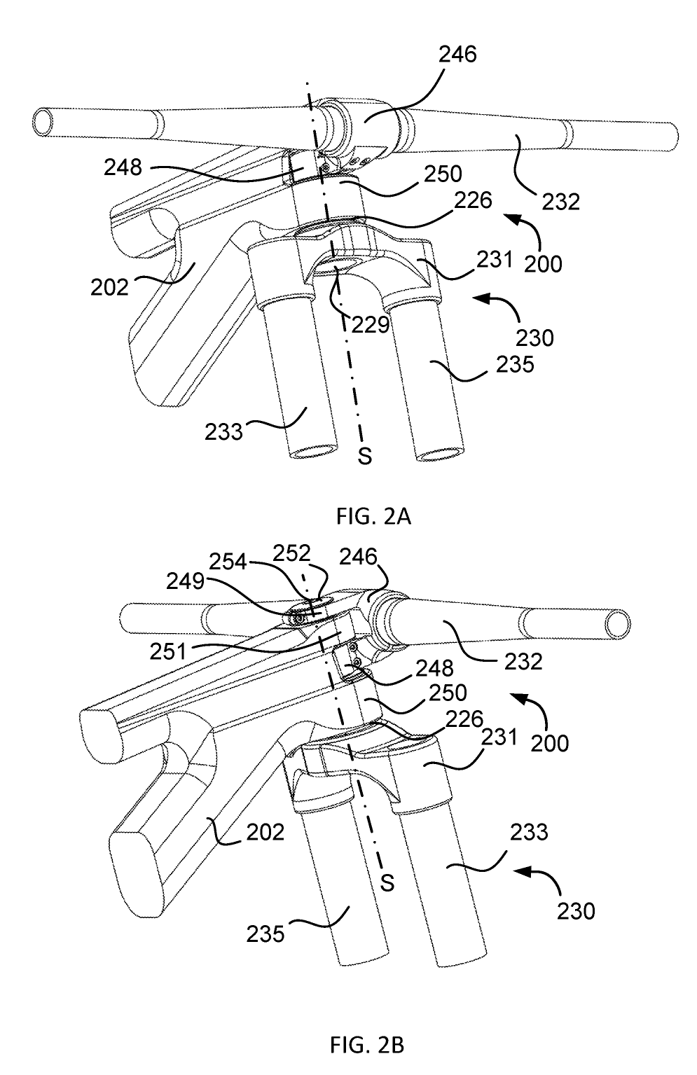

Turning now to FIG. 2A, a perspective view of an example steering device 200 mounted to a frame 202 of a bicycle is provided. As shown in FIG. 2A, the steering device 200 includes a stem 246 attached to a steerer 229 of a front fork 230. The steerer 229 as shown is attached to the front fork 230 through a crown 231. The steerer 229 may be press fit, mechanically locked, and or adhesively locked with the crown 231. The steerer 229 may also be unitarily formed with the crown 231. The stem 246 as shown may be clamped to the steerer 229 in at least one position, for example with a first steerer clamp 248 as shown. The first steerer clamp 248 is positioned above a lower head tube 250 of the frame 202 and is configured to be fixed relative to the steerer 229 such that the stem 246 rotates in unison with the front fork 230. The stem 246 is also attachable to a handlebar 232, thus allowing a rider to steer the front fork 230 via the handlebar 232. The front fork 230 is pivotable about the frame 202 via a headset 226. Rotation of the front fork 230 is used to control a front wheel, for example as shown with the front wheel 104 of FIG. 1, through at least one fork leg. As shown in FIG. 2A, a first leg 233 and a second leg 235 may be provided. The first leg 233 and the second leg 235 as shown are part of a right side up suspension fork. However, it should be appreciated that various configurations may be provided including upside down suspension forks, single-sided suspension forks, and various rigid forks.

Turning to FIG. 2B, a reversed perspective view of the example steering device 200 of FIG. 2A is provided. As shown in FIG. 2B, the frame 202 may further include an upper head tube 251. The upper head tube 251 may be at least in part spaced apart from the lower head tube 250. For example, as shown in FIG. 2B, at least a portion of the stem 246 may be disposed between the upper head tube 251 and the lower head tube 250. As shown, the first steerer clamp 248 is positioned between the upper head tube 251 and the lower head tube 250 and operable to clamp the steerer 229 between the upper head tube 251 and the lower head tube 250.

Still referring to FIG. 2B, a second steerer clamp 249 may be provided with the stem 246. As shown, the second steerer clamp 249 is operable to clamp the steerer 229 above the upper head tube 251. The second steerer clamp 249 may be used to provide strength and/or stiffness to the steering device 200 while maintaining a low profile and relatively low position for the handlebar 232. The second steerer clamp 249 may also be used to control tension on the headset 226. For example, a preload device 254 may be used to add axial load to the headset 226 along a steering axis S. As shown, the preload device 254 includes a fastener that is connectable between the steerer 229 and the stem 246. The preload device 254 may thus resolve forces between the frame 202 and the fork 230 to preload bearings of the headset 226. The preload device 254 as shown in the example of FIG. 2B acts on the frame 202 through a top cap 252, which in turn acts on the second steerer clamp 249 of the stem 246, which in turn acts on an upper portion of the headset 226.

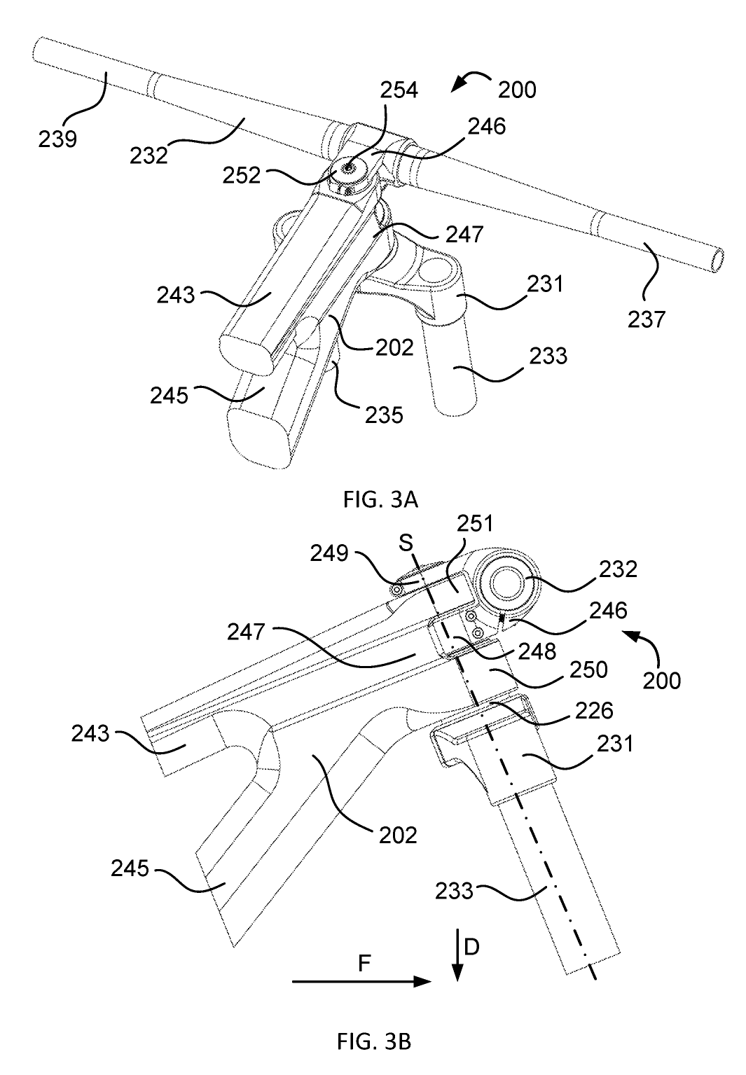

Turning now to FIG. 3A, an upper perspective view of the steering device 200 of FIG. 2A is provided. As shown in FIG. 3A the handlebar 232 may include at least one control portion. For example, the handlebar 232 may include a first control portion 237 and a second control portion 239. The first and second control portions 237, 239 may generally be used for hand placement and may include various control features including brake levers, dropper post levers, shift levers, and/or various electronic controls.

The example of FIG. 3A further shows that the frame 202 may include one or more individual elements. For example, as previously described above, the frame 202 may include an upper head tube 251 and a lower head tube 250. The upper head tube 251 and the lower head tube 250 may collectively be referred to as a head tube 247. The frame 202 may further include a top tube 243 and a down tube 245. Although these example elements of the frame 202 are referred to as tubes, it should be appreciated that various shapes and configurations of these elements may be used. For example, the frame 202 may be a unitary component, for example a monocoque composite construction, wherein the described elements may not have clearly delineated boundaries. In some examples, the top tube 243 and the down tube 245 may blend together to at some point form the head tube 247.

FIG. 3B is a side view of the steering device 200 shown in FIG. 3A. As illustrated in FIG. 3B, the steering device 200 is configured to facilitate relatively compact positioning of the handlebar 232 relative to the frame 202 in the forward riding direction F. Additionally, the steering device 200 allows positioning of the handlebar 232 relatively low in a downward direction D perpendicular to the forward riding direction F. It should be appreciated that, particularly with large diameter wheels such as nominal 29 inch, 32 inch, or 36 inch diameter wheels, relatively compact positioning of the handlebar 232 in the forward riding direction F and the downward direction D as shown herein may be ergonomically desirable.

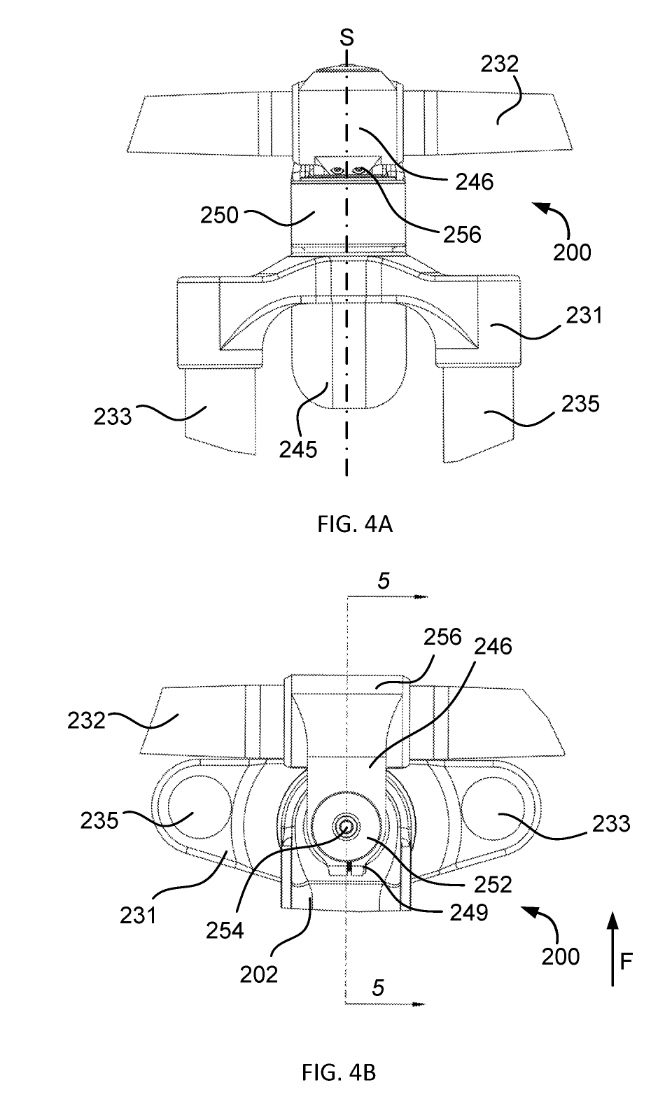

Turning now to FIG. 4A, a front view of the steering device 200 of FIG. 2A is provided. As shown in FIG. 4A, the stem 246 includes a handlebar clamp 256 for attachment of the handlebar 232. As shown, the handlebar clamp 256 may be a one piece design, allowing the handlebar 232 to be released and removed through the opening and to be clamped in place with one or more fasteners. However, it should also be appreciated that the handlebar clamp 256 may be a multi part design, for example to allow removal of the handlebar 232 through disassembly of the handlebar clamp 256 into two or more pieces. In an embodiment, the handlebar 232 may be integrated with the stem 246, for example as a unitary component as in monocoque composite or 3D forged metallic constructions.

Turning to FIG. 4B, a top view of the steering device 200 of FIG. 2A is provided. As shown in FIG. 4B, the crown 231 may be configured to receive the first leg 233 and the second leg 235. For example, the crown 231 may be provided with corresponding openings for receiving the first leg 233 and the second leg 235. In certain examples, controls for the first leg 233 and the second leg 235 may be provided in the corresponding openings of the crown 231. For example, the first leg 233 may include damping controls and the second leg 235 may include air spring controls or fluid access in the corresponding openings.

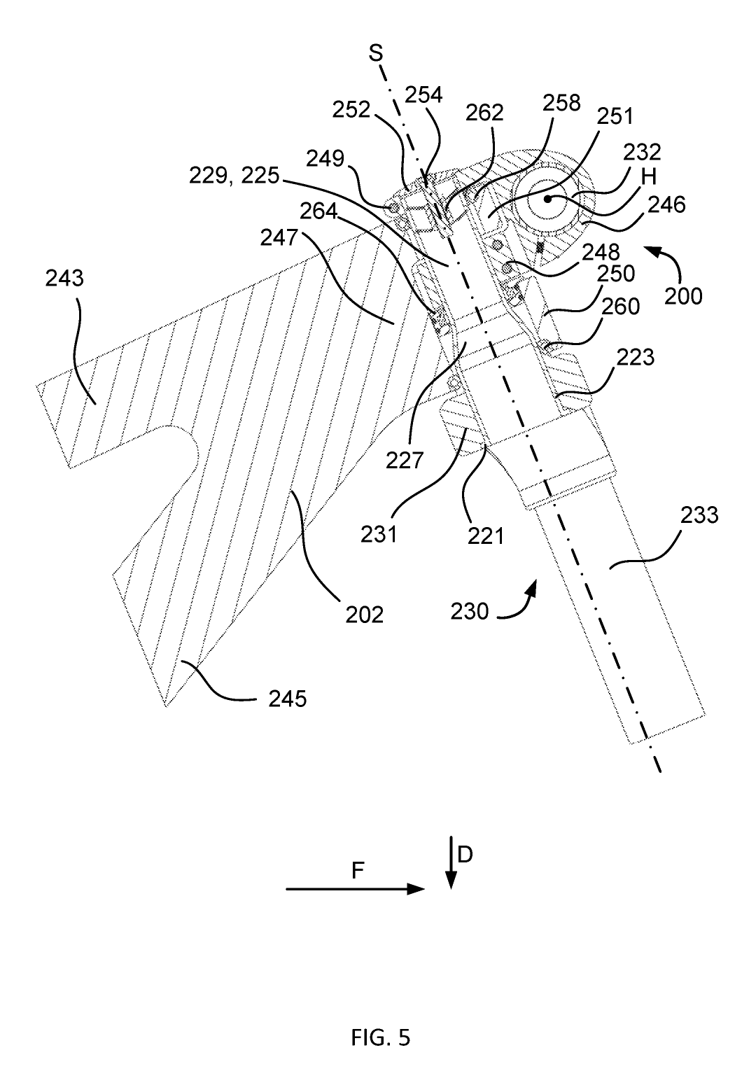

Turning now to FIG. 5, a sectional view of the steering device 200 is provided as taken along line 5-5 in FIG. 4B. As shown in FIG. 5, the frame 202 incorporates an integrated headset having an upper bearing 258 and a lower bearing 260. It should be appreciated that other headset configurations may also be applied to various steering devices described herein, including at least pressed in or threaded in headset cups holding the upper bearing 258 and/or the lower bearing 260. As described above, the upper bearing 258 and the lower bearing 260 may be preloaded. For example, the preload device 254 may be used to tension the steerer 229. As shown in FIG. 5, the preload device 254 may tension the steerer 229 through a steerer connection 262. The steerer connection 262 may be an integrated part of the steerer 229, may be a compression fitting, or may be a star nut configuration pressed into the steerer 229 as shown in FIG. 5. The preload device 254 tensions against the top cap 252, which in turn tensions against the stem 246, which in turn tensions against the upper bearing 258. The steerer connection 262 transmits force from the preload device through the steerer 229, to the crown 231, which in turn transmits force to the lower bearing 260. Accordingly, the upper bearing 258 and the lower bearing 260 may be simultaneously preloaded through operation of the preload device 254.

Still referring to FIG. 5, the steerer 229 may be described in various portions. The steerer 229 shown in FIG. 5 includes a steerer first portion 223, a steerer second portion 225, and a steerer transition portion 227. The steerer first portion 223 includes a steerer engagement feature 221. As shown, the steerer engagement feature 221 serves to locate the steerer 229 relative to the crown 231 during assembly as the steerer 229 is pressed into the crown 231. As described elsewhere herein, it should be appreciated that the steerer 229 need not necessarily be pressed into the crown 231 and may be otherwise fixed with or integral to the crown 231.

In FIG. 5, the steerer first portion 223 may generally be defined as having a first outer diameter, for example a generally consistent first outer diameter. The first outer diameter as shown is used for interfacing with the crown 231 and the lower bearing 260. The crown 231 as shown in FIG. 5 includes an integral crown race configured for locating the lower bearing 260. However, various other crown race configurations may be employed, including a removable crown race press fit over the steerer 229.

The steerer second portion 225 as shown in FIG. 5 may generally be defined as a having a second outer diameter, for example a generally consistent second outer diameter. The second outer diameter of the steerer second portion 225 is smaller than the first outer diameter of the steerer first portion 223. As shown in FIG. 5, the second outer diameter of the steerer second portion 225 is shaped and sized for receiving the stem 246, for example the first steerer clamp 248 and the second steerer clamp 249. In some examples, the first steerer clamp 248 and the second steerer clamp 249 are each similarly dimensioned to correspond with the second outer diameter of the steerer second portion 225.

Still referring to FIG. 5, a steerer transition portion 227 is provided between the steerer first portion 223 and the steerer second portion 225. The steerer transition portion 227 may be referred to as a tapered portion in some examples. The steerer transition portion 227 of FIG. 5 transitions the steerer 229 between the first outer diameter of the first steerer portion 223 and the second outer diameter of the second steerer portion 225. As will be described in greater detail below, it may be desirable to implement a relatively short length of the steerer transition portion 227, for example to provide the second outer diameter of the second steerer portion 225 at a relatively low point in the downward direction D for clamping of the stem 246, for example with the first steerer clamp 248.

As shown in FIG. 5, positioning of the handlebar 232 and other elements of the steering device 200 may be referred to at least in part with a handlebar axis H. The handlebar axis H generally refers to an axis of the handlebar 232 within and/or near the handlebar clamp 256 of the stem 246. For example, the handlebar axis H may also refer to a concentric opening of the handlebar clamp 256 of the stem 246. As shown in FIG. 5, the handlebar axis H may generally be orthogonal to the forward riding direction F and the downward direction D while the handlebar is aligned for straight travel in the forward riding direction F as presently depicted.

Also shown in FIG. 5, a sealing arrangement 264 may be provided. The sealing arrangement 264 as shown is disposed between the lower head tube 250 and the upper head tube 251 along the steering axis S. The sealing arrangement 264 may be operable to control ingress to an interior of the frame 202 between the lower head tube 250 and the upper head tube 251. For example, the sealing arrangement 264 may provide a seal between the steerer 229, the upper head tube 251, and/or the lower head tube 250.

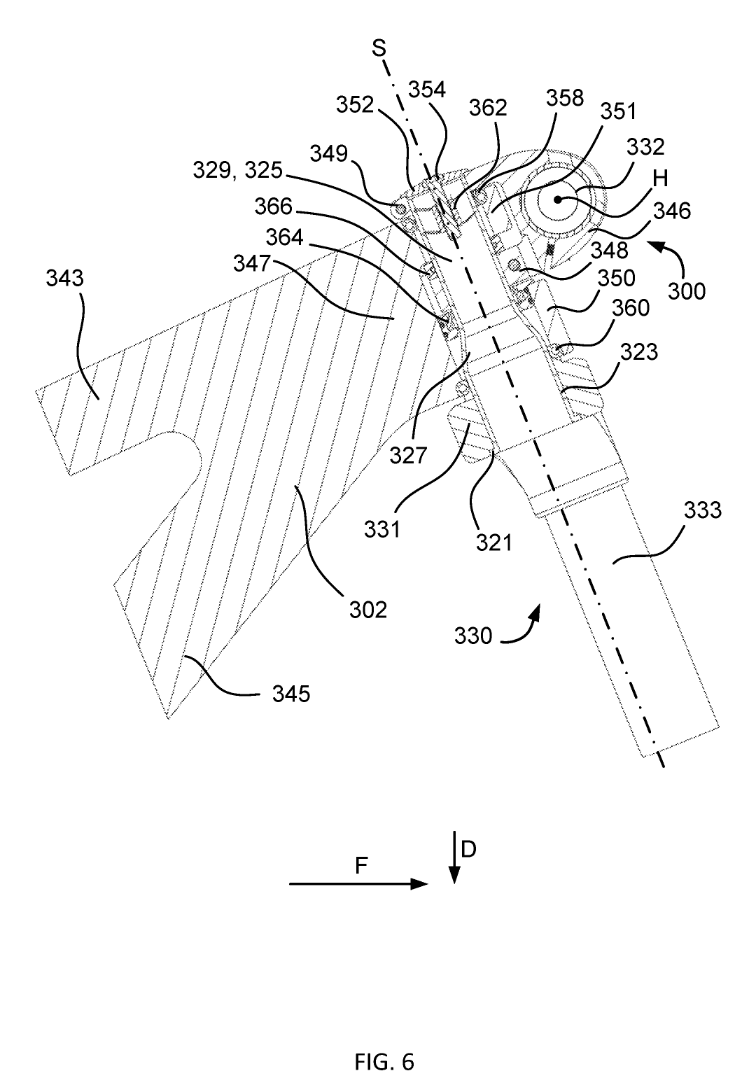

Turning now to FIG. 6, a sectional view of another example of a steering device 300 is shown in a first position. The steering device 300 is generally shown from a view similar to the steering device 200 as shown in FIG. 5. In FIG. 6, the steering device 300 is shown as attached to a frame 302. The frame 302 generally includes a top tube 343, a down tube 345, and a head tube 347, which in turn includes a lower head tube 350 and an upper head tube 351. A front fork 330 is rotatably attached to the frame 302 via an upper bearing 358 and a lower bearing 360. Although only a first leg 333 is visible in the view of FIG. 6, it should be appreciated that other fork components may be included in various combinations. The lower bearing 360 and the upper bearing 358 interface with one or more outer diameters of a steerer 329. The lower bearing 358 further interfaces with a crown 331 of the front fork 330 and the upper bearing 358 further interfaces with a stem 346. Specifically, the stem 346 includes a first steerer clamp 348 and a second steerer clamp 349 attachable to the steerer 329, wherein the second steerer clamp 349 is further used to interface between a preload device 354 and the upper bearing 358. As shown, the preload device 354 is operable to apply tension between a top cap 352 acting on the second steerer clamp 349 of the stem 346 and a steerer connection 362 acting on the steerer 329.

Still referring to FIG. 6, a handlebar 332 may be clamped to the stem 346, for example about the handlebar axis H as described above with reference to FIG. 5. The stem 346 as shown is clamped about the steerer 329 at a steerer second portion 325. The steerer 329 further includes a steerer first portion 323 engaged with the crown 331 and the lower bearing 360 and a steerer transition portion 327 disposed between the steerer first portion 323 and the steerer second portion 325. A steerer engagement feature 321 is provided to locate the steerer 329 relative to the crown 331.

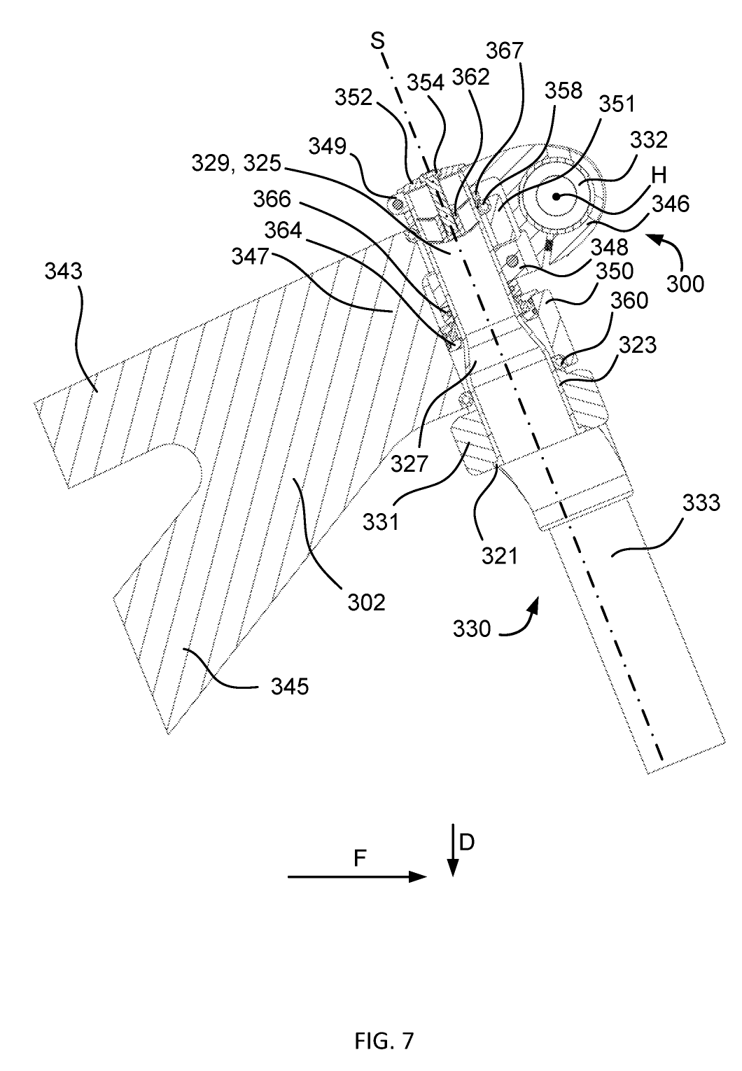

In the example of FIG. 6, a sealing arrangement 364 is provided between the upper bearing 358 and the lower bearing 360 along the steering axis S. As shown, the sealing arrangement 364 provides sealing between the lower head tube 350 and the steerer 329 while allowing relative rotation between the lower head tube 350 and the steerer 329. The example of FIG. 6 further provides a steerer spacer 366 disposed between the upper head tube 351 and the first steerer clamp 348 along the steering axis S. The steerer spacer 366 fits around the steerer second portion 325 and may be clamped, friction fit or loosely fit around the steerer 329. As shown in FIG. 6, the steerer spacer 366 may include a sealing or locating element such as an O-ring. The steerer spacer 366 may be used to at least in part to facilitate sealing by reducing open space into an interior of the frame 302. The steerer spacer 366 may further assist in locating the stem 346. As shown in FIG. 6, the steerer spacer 366 disposed above the first steerer clamp 348 of the stem 346 provides the first position, also referred to as a low position, of the present example. As shown in the example of FIG. 7, a second position may be provided by relocating the steerer spacer 366.

Turning now to FIG. 7, a sectional view of the steering device 300 of FIG. 6 is shown in a second position. As described above, the steerer spacer 366 may be repositioned to achieve the depicted second position. The steerer spacer 366 in FIG. 7 is disposed between the sealing arrangement 364 and the first steerer clamp 348 along the steering axis S. This positioning of the steerer spacer 366 achieves the depicted second position, also referred to as a high position, of the present example, locating the handlebar axis H higher in the downward direction than in the example of FIG. 6 depicting the low position. The example of FIG. 7 further includes a preload spacer 367. The preload spacer 367 is provided between the upper bearing 358 and the second steerer clamp 349 of the stem 346. The preload spacer 367 is provided to transmit preload force between the preload device 354 and the upper bearing 358 through the stem 346.

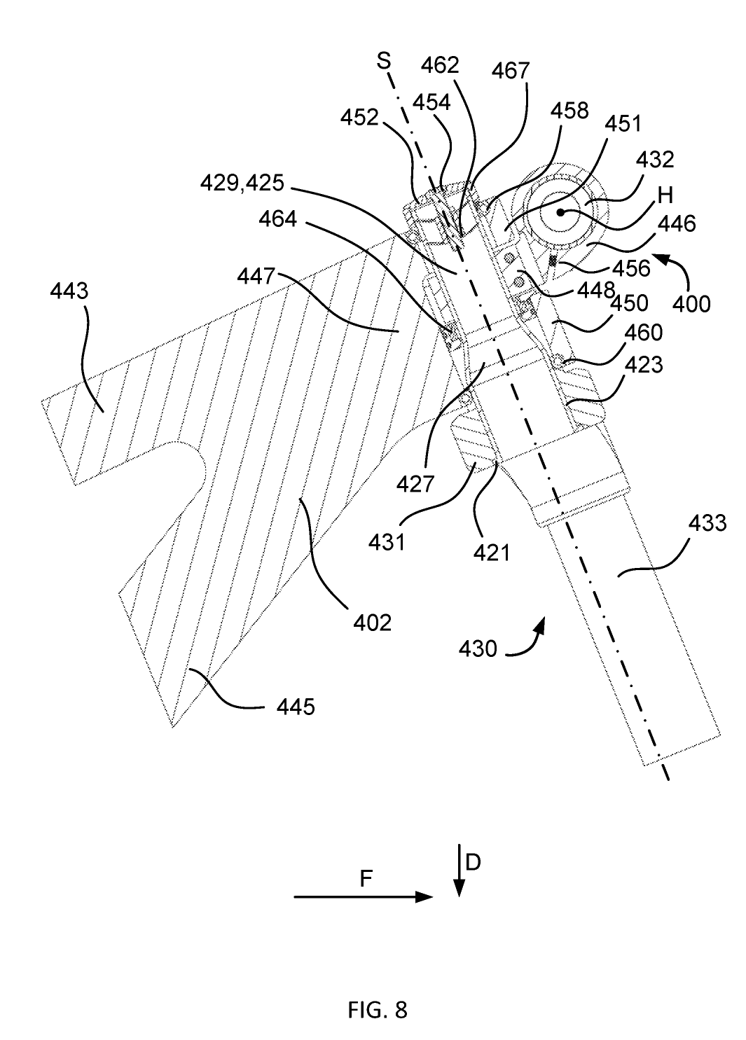

Turning now to FIG. 8, a sectional view of another example of a steering device 400 is provided. The steering device 400 is generally shown from a view similar to the steering device 200 as shown in FIG. 5. In FIG. 8, the steering device 400 is shown as attached to a frame 402. The frame 402 generally includes a top tube 443, a down tube 445, and a head tube 447, which in turn includes a lower head tube 450 and an upper head tube 451. A front fork 430 is rotatably attached to the frame 402 via an upper bearing 458 and a lower bearing 460. Although only a first leg 433 is visible in the view of FIG. 8, it should be appreciated that other fork components may be included in various combinations. The lower bearing 460 and the upper bearing 458 interface with one or more outer diameters of a steerer 429. The lower bearing 458 further interfaces with a crown 431 of the front fork 430 and the upper bearing 458 further interfaces with a preload spacer 467.

The stem 446 shown in FIG. 8 includes a single steerer clamp 448 attachable to the steerer 429. As shown, a preload device 454 is operable to apply tension between a top cap 452 acting on the preload spacer 467 and a steerer connection 462 acting on the steerer 429.

Still referring to FIG. 8, a handlebar 332 may be clamped to the stem 446, for example about the handlebar axis H with a handlebar clamp 456 as described above with reference to FIG. 5. The stem 446 as shown is clamped about the steerer 429 at a steerer second portion 425. The steerer 429 further includes a steerer first portion engaged with the crown 431 and the lower bearing 460 and a steerer transition portion 427 disposed between the steerer first portion 423 and the steerer second portion 425. A steerer engagement feature 421 is provided to locate the steerer 429 relative to the crown 431.

In the example of FIG. 8, a sealing arrangement 464 is provided between the upper bearing 458 and the lower bearing 460 along the steering axis S. As shown, the sealing arrangement 464 provides sealing between the lower head tube 450 and the steerer 429 while allowing relative rotation between the lower head tube 450 and the steerer 429.

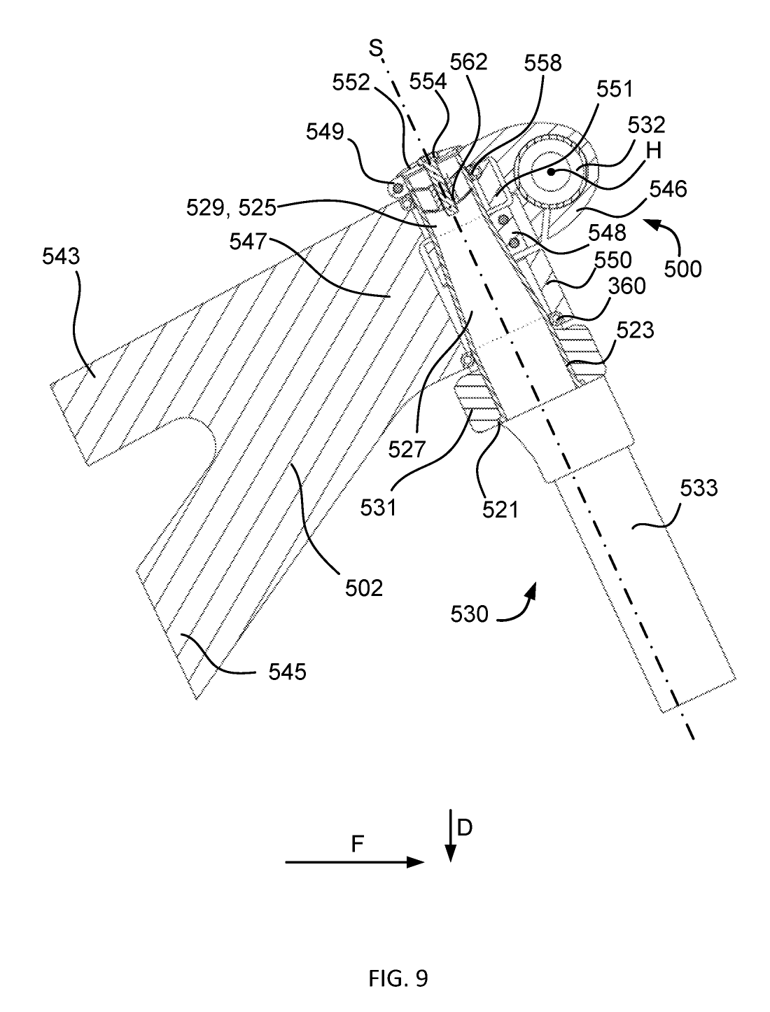

Turning now to FIG. 9, a sectional view of a steering device 500 is provided. The steering device 500 is generally shown from a view similar to the steering device 200 as shown in FIG. 5. In FIG. 9, the steering device 500 is shown as attached to a frame 502. The frame 502 generally includes a top tube 543, a down tube 545, and a head tube 547, which in turn includes a lower head tube 550 and an upper head tube 551. A front fork 530 is rotatably attached to the frame 502 via an upper bearing 558 and a lower bearing 560. Although only a first leg 533 is visible in the view of FIG. 9, it should be appreciated that other fork components may be included in various combinations. The lower bearing 560 and the upper bearing 558 interface with one or more outer diameters of a steerer 529. The lower bearing 558 further interfaces with a crown 531 of the front fork 530 and the upper bearing 558 further interfaces with a stem 546. Specifically, the stem 546 includes a first steerer clamp 548 and a second steerer clamp 549 attachable to the steerer 529, wherein the second steerer clamp 549 is further used to interface between a preload device 554 and the upper bearing 558. As shown, the preload device 554 is operable to apply tension between a top cap 552 acting on the second steerer clamp 549 of the stem 546 and a steerer connection 562 acting on the steerer 529.

Still referring to FIG. 9, a handlebar 532 may be clamped to the stem 546, for example about the handlebar axis H as described above with reference to FIG. 5. The stem 546 as shown is clamped about the steerer 529 at a steerer transition portion 527. The steerer 529 further includes a steerer first portion 523 engaged with the crown 331 and the lower bearing 360 and a steerer second portion 527 disposed above the steerer transition portion 527. A steerer engagement feature 521 is provided to locate the steerer 529 relative to the crown 331.

As can be seen in the example of FIG. 9, the stem 546 may be configured to clamp around the steerer transition portion 527. For example, the first steerer clamp 548 of the stem 546 may be sized and shaped to fit around a tapered configuration of the steerer transition portion 527. Although not shown, an intermediate component may be provided between the first steerer clamp 548 and the steerer transition portion 527, for example to provide a consistent outer diameter to interface with the first steerer clamp 548 and a tapered inner diameter to interface with the steerer transition portion 527. As shown in FIG. 9, clamping of the stem 546 with the second steerer clamp 549 may positively lock the stem 546 to the steerer second portion 525 while clamping of the first steerer clamp 548 around the steerer transition portion 527 may provide additional strength and/or stiffness to the attachment between the stem 546 and the steerer 529.

In the example of FIG. 9, a sealing arrangement is not explicitly provided between the upper bearing 558 and the lower bearing 560 along the steering axis S. However, the stem 546 may be sized and shaped to minimize gaps and thus environmental ingress into the frame 502.

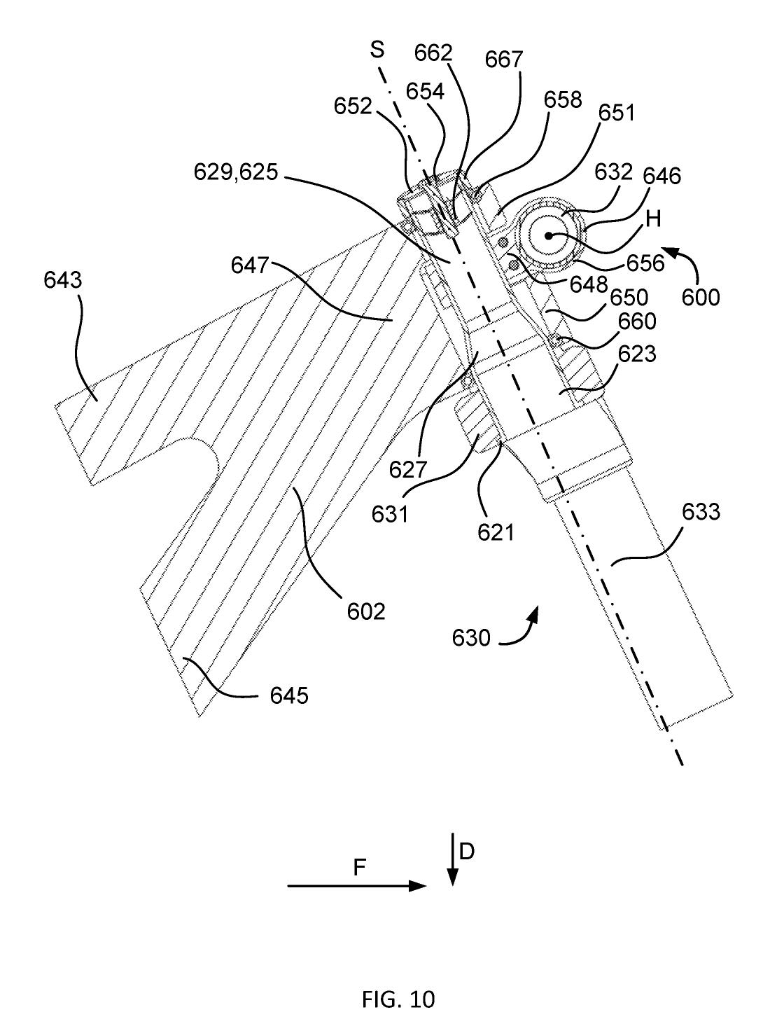

Turning now to the example of FIG. 10, a sectional view of another example of a steering device 600 is provided. The steering device 600 is generally shown from a view similar to the steering device 200 as shown in FIG. 5. In FIG. 10, the steering device 600 is shown as attached to a frame 602. The frame 602 generally includes a top tube 643, a down tube 645, and a head tube 647, which in turn includes a lower head tube 650 and an upper head tube 651. A front fork 630 is rotatably attached to the frame 602 via an upper bearing 658 and a lower bearing 660. Although only a first leg 633 is visible in the view of FIG. 10, it should be appreciated that other fork components may be included in various combinations. The lower bearing 660 and the upper bearing 658 interface with one or more outer diameters of a steerer 629. The lower bearing 658 further interfaces with a crown 631 of the front fork 630 and the upper bearing 658 further interfaces with a preload spacer 667.

The stem 646 shown in FIG. 10 includes a single steerer clamp 648 attachable to the steerer 629. As shown, a preload device 654 is operable to apply tension between a top cap 652 acting on the preload spacer 667 and a steerer connection 662 acting on the steerer 629. A sealing arrangement is not explicitly provided between the upper bearing 658 and the lower bearing 660 along the steering axis S. However, the stem 646 may be sized and shaped to minimize gaps and thus environmental ingress into the frame 602. As shown in FIG. 10, the stem may be shaped so as to overlap gaps between the stem 646 and the lower head tube 650 and/or between the stem 646 and the upper head tube 651. Accordingly, the stem 646 may be sized and shaped to provide an integral sealing arrangement. However, it should also be appreciated that various independent sealing arrangements may also be provided with such an example as shown and described with reference to other embodiments herein.

Still referring to FIG. 10, a handlebar 632 may be clamped to the stem 646, for example about the handlebar axis H with a handlebar clamp 656 as described above with reference to FIG. 5. The stem 646 as shown is clamped about the steerer 629 at a steerer second portion 625. The steerer 629 further includes a steerer first portion 623 engaged with the crown 631 and the lower bearing 660 and a steerer transition portion 627 disposed between the steerer first portion 623 and the steerer second portion 625. A steerer engagement feature 621 is provided to locate the steerer 629 relative to the crown 631.

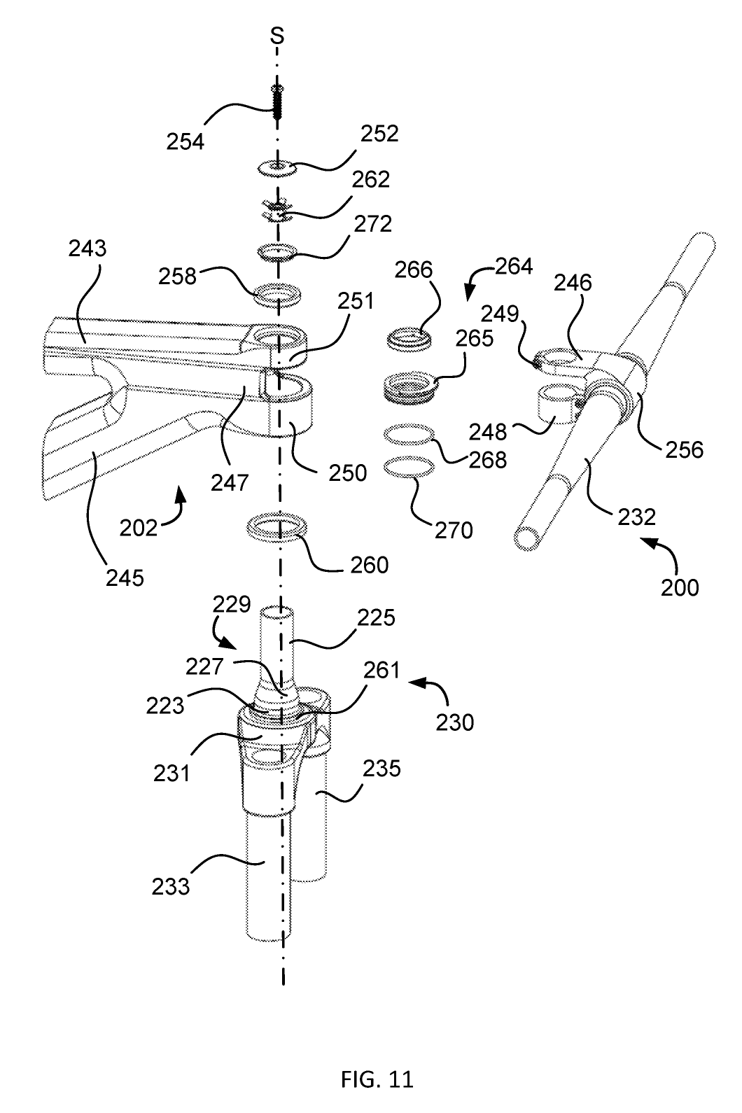

Turning now to FIG. 11, an exploded view of the steering device 200 of FIG. 2A is provided. As shown in FIG. 11, the sealing arrangement 264 may include various elements. A shield element 265 is provided to positively locate various sealing elements. An inner seal 266 is provided and may be configured as a lip seal or any other suitable sealing element. The inner seal 266 is sized and shaped to provide a sealing interface between the shield element 265 and the steerer 229, for example the steerer second portion 225. At least one outer seal may also be provided, for example the first outer seal 268 to provide a sealing interface between the shield element 265 and the head tube 247. A second outer seal 270 is also shown in FIG. 11, providing a seal between the shield element 265 and the lower head tube 250. Although the elements of the sealing arrangement 264 are shown as individual elements of an assembly, it should be appreciated that one or all of these elements may be provided as a single element, for example as an overmolded sealing arrangement.

Still referring to FIG. 11, a crown race 261 is shown. The crown race 261 may be an individual element or may be integrated with one or more of the steerer 229 or the crown 231. The crown race 261 may generally be configured to interface with the lower bearing 260. For example, the crown race 261 may provide centering or other positive location of the lower bearing 260. In embodiments where the lowering bearing 260 is not a cartridge bearing, the crown race 261 may provide a bearing surface, for example to enable the running of bearing elements.

The exploded view of FIG. 11 further shows a centering element 272 above the upper bearing 258. The centering element 272 may be an individual element or may be combined with various other elements, for example the second steerer clamp 249 of the stem or a preload spacer such as the preload spacer 367 described above. Still referring to FIG. 11, the centering element 272 interfaces with the upper bearing 258 to provide positive location of the upper bearing 258 and to facilitate effective preloading of the headset 226.

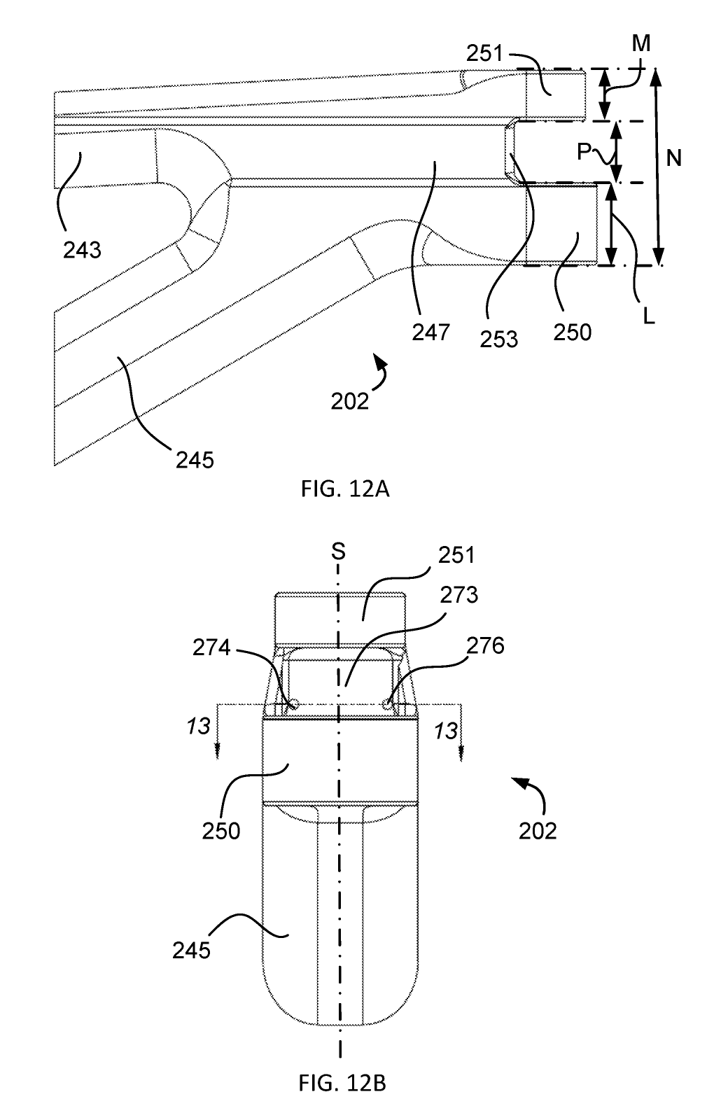

Turning to FIG. 12A, a partial side view of the frame 202 as shown in FIG. 2A is provided. As shown in FIG. 12A, the head tube 247 may be defined to include a head tube intermediate portion 253. As shown, the head tube intermediate portion 253 provides a mounting clearance for the stem (not shown) to interface with the steerer (not shown) between the lower head tube 250 and the upper head tube 251. The head tube intermediate portion 253 may be defined with an intermediate head tube length P. As shown, the intermediate head tube length P is less than a head tube length N that is inclusive of the intermediate head tube length P. For example, the intermediate head tube length P may be less than half of the head tube length N.

The head tube length N further includes an upper head tube length M measuring the extent of the upper head tube 251 and a lower head tube length L measuring the extent of the lower head tube 250. As shown, the upper head tube length M may be less than the lower head tube length L and may be less than the intermediate head tube length P. In some examples, the lower head tube length L may be at least half of the head tube length N. The frame 202 may be sized according to the lower head tube length L. For example, the upper head tube length M and/or the intermediate head tube length P may be constrained sizes based on the fitting of standardized steering elements such as the stems described with reference to various examples herein. Accordingly, a relatively large frame size may be achieved with a relatively large lower head tube length L and a relatively small frame size may be achieved with a relatively small lower head tube length L, while both frame sizes may have similar or identical upper head tube length M and intermediate head tube length P.

Turning now to FIG. 12B, a front view of the frame 202 as shown in FIG. 12A is provided. As can be seen in FIG. 12B, access to a frame interior 273 is provided between the lower head tube 250 and the upper head tube 251. For example, access to the frame interior 273 may be provided along the entirety of the intermediate head tube length P when other components are not installed. As shown in FIG. 12B, one or more internal features may be provided. For example, at least one port for routing of Bowden cables, electrical wires, hydraulic lines, or the like may be provided. In the present example, a first port 274 and a second port 276 are provided for controlled routing of control cables, hoses, or wires into the frame interior 273.

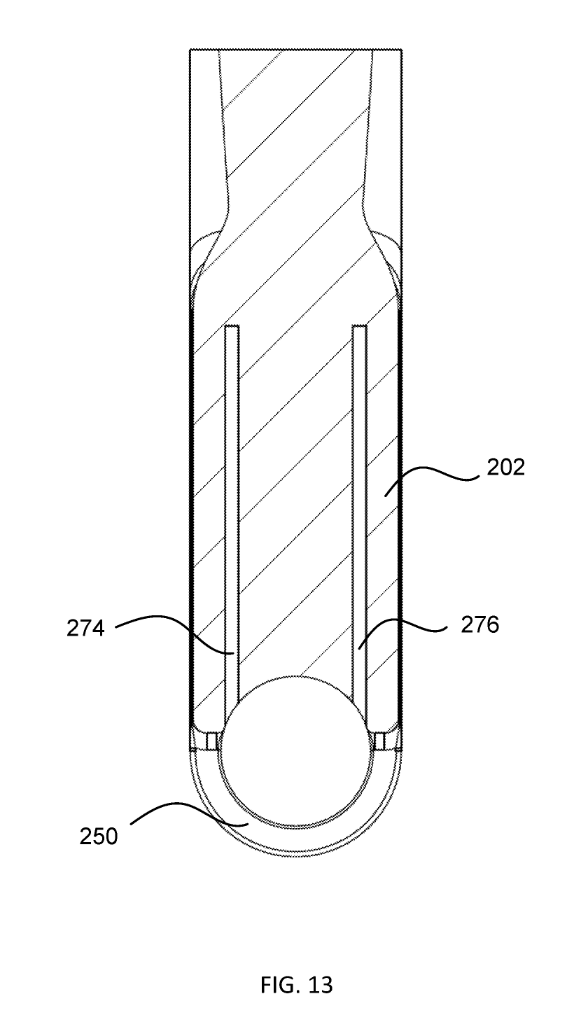

Turning to FIG. 13, a sectional view of the frame 202 is shown as taken along line 13-13 in FIG. 12B. As shown in FIG. 13, the first port 274 and the second port 276 may provide controlled access to the frame interior 273 even when all elements of the bicycle are assembled. For example, the steering device 200 may be configured to provide routing of hoses, cables, and/or wires through at least one of the first port 274 and the second port 276. The first port 274 and the second port 276 may be configured with various features including cable stops or electrical junction boxes to aid in control routing.

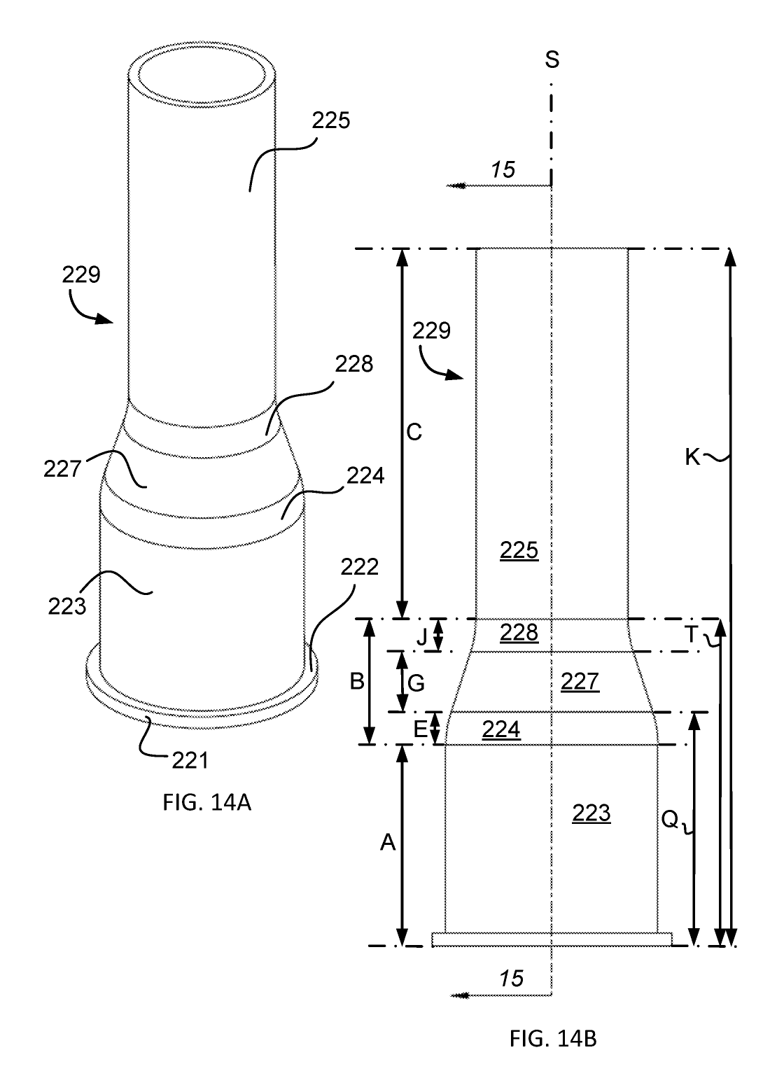

Turning now to FIG. 14A, a perspective view of the steerer 229 is provided. As shown in the exploded view of FIG. 11, the steerer 229 may be assembled with the front fork 230 permanently or semi-permanently. For example, the steerer 229 may be molded or forged integrally with the front fork 230. In another example, the steerer 229 may be pressed and/or adhered to the front fork 230. In the present example, the steerer 229 is sized and shaped to be inserted into the crown 231 of the front fork 230 and retained with friction and/or adhesive. As can be seen in FIG. 14A, the steerer engagement feature 221 is shaped and sized to locate a maximum insertion of the steerer 229 into the crown 231. As shown in FIG. 14A, an engagement surface 222 is provided on the steerer engagement feature 221 to engage with a corresponding surface (not shown) of the crown 231.

In the example of FIG. 14A, the steerer transition portion 227 is shown to further include a lower bend 224 and an upper bend 228. The lower bend 224 and the upper bend 228 as used herein refer to a radiused portion of the steerer 229. Between the upper bend 228 and the lower bend 224, the remainder of the steerer transition portion 227 may be straight, for example defining a consistent angle between the steerer first portion 223 and the steerer second portion 225. It should be appreciated that the upper bend 228 and the lower bend 224 may be eliminated or reduced in dimension or that the entirety of the steerer transition portion may be curved.

FIG. 14B is a side view of the steerer 229 of FIG. 14A. The steerer 229 in FIG. 14B is provided with various exemplary dimensions. A steerer length K is provided to represent an entirety of the steerer, for example along the steering axis S as described above. A second portion length C describes the extent of the steerer second portion 225 along the steering axis S. The steerer length K may generally be tunable by changing of the second portion length C, for example by shortening as needed to provide attachment of steering and preloading elements as described elsewhere herein. A first portion length A represents a total extent of the steerer first portion 223. A transition portion length B represents a total extent of the steerer transition portion 227, shown here to include the first bend 224 and the second bend 228. In this example, the transition portion length B includes a first bend length E, a second bend length J, and a straight transition length G. The straight transition length J may account for approximately half or less of the transition portion length B, for example to facilitate a relatively short transition between the steerer first portion 223 and the steerer second portion 225.

Still referring to FIG. 14B, a pre-transition length Q may be provided to describe a maximum extent of the steerer 229 below the straight wall section of the steerer transition portion 227. The pre-transition length Q may for example include a small controlled outer diameter of the steerer 229 for mounting a crown race as described elsewhere herein. The first portion length A and/or the pre-transition length Q may be sized generally to account for related dimensions of a crown of a fork as described above and a lower bearing as described above. In an example, the first portion length A is sized such that all of, or almost all of the first portion length A is overlapped by a crown and lower bearing once installed. In some examples, the transition portion length B is less than the first portion length A. For example, the transition portion length B may be less than 90%, 80%, 70%, 60%, or 50% of the first portion length A. The transition portion length B may be tuned to be relatively short compared to the first portion length A, for example to facilitate mounting of a stem to the steerer second portion 225 below the upper head tube 251 as described elsewhere herein. A lower steerer length T may be used to define this total extent prior to the start of the steerer second portion 225.

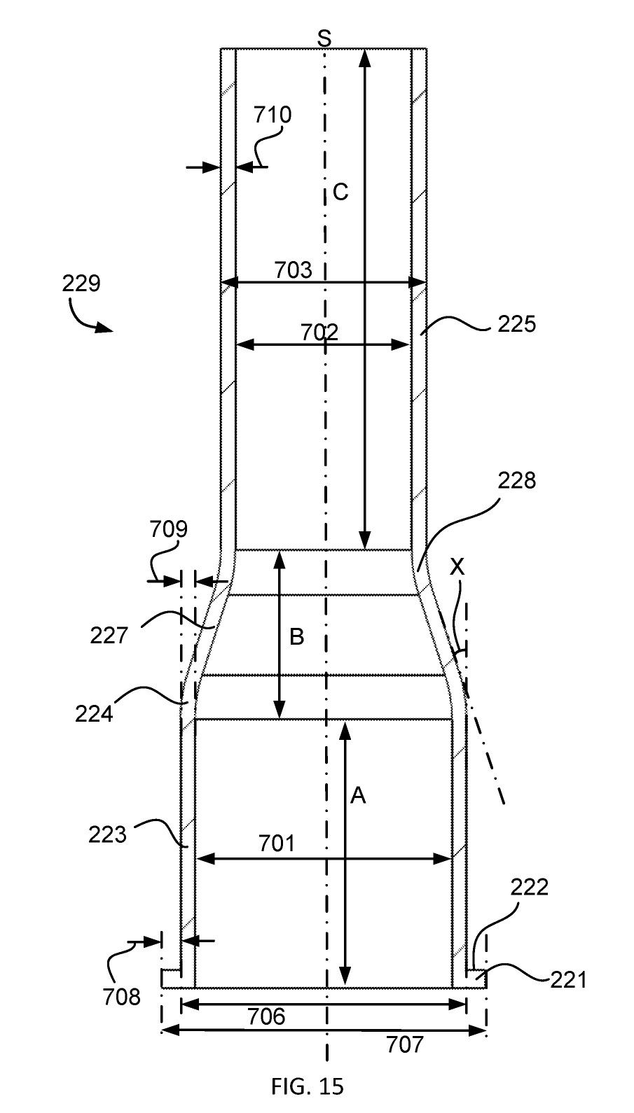

Turning now to FIG. 15, a sectional view of the steerer 229 is shown as taken along line 15-15 in FIG. 14B. A total engagement dimension 707 is provided, showing a maximum extent of the steerer 229 orthogonal to the steering axis S. An external engagement dimension 708 describes the extent of the steerer engagement feature 221 beyond a first external dimension 706 of the steerer first portion 223. The external engagement dimension 708 generally describes an extent of the engagement surface 222. A first internal dimension 701 describes the internal extent orthogonal to the steering axis S of the steerer first portion 223. A first wall thickness may be described as the difference between the first internal dimension 701 and the first external dimension 706. The first wall thickness 709 may be consistent or variable. For example, the first wall thickness 709 may be tuned across its extent based on strength and weight requirements.

Still referring to FIG. 15, a second internal dimension 702 describes a total extent orthogonal to the steering axis S of the steerer second portion 225, while a second external dimension 703 describes a corresponding external extent. A second wall thickness 710 may be defined between the second external dimension 703 and the second internal dimension 702 and may be consistent or variable.

In various examples, the second external dimension 703 may be substantially less than first external dimension 706. For example, the second external dimension 703 may be less than 80%, 75%, 72%, or 70% of the first external dimension 706. Accordingly, the steerer first portion 223 may be tuned to provide strength and stiffness while allowing a relatively lightweight and compact dimension of the steerer second portion 225 for clamping of a stem. Dimensions described herein may facilitate strong and compact transitioning between relatively disparate first and second external dimensions to provide for mounting of steering devices as described herein.

A transition angle X may be defined between the steerer first portion 223 and the steerer second portion 225. As shown, the transition angle X is defined in FIG. 15 as an angle of the steerer transition portion 227 relative to the steerer first portion 223. The transition angle X may also be defined relative to the steering axis S, which is generally parallel with the vertical extent of the steerer first portion 223 as shown in FIG. 15. The transition angle X may be relatively large to facilitate a short transition length (for example the transition portion length B) along the steering axis S. In an example, the transition angle X is at least 10 degrees, and may be at least 15, 20, 25, 30, 35, or 40 degrees.

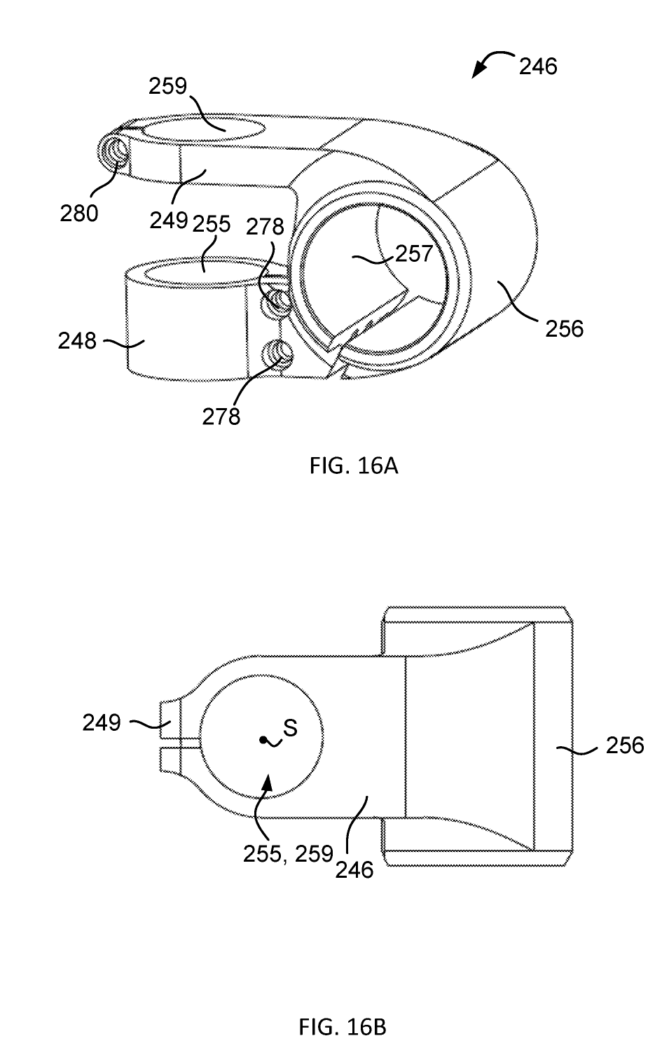

Turning now to FIG. 16A, a perspective view of the stem 246 as shown in FIG. 2A is provided. As shown, the stem 246 includes a handlebar mounting surface 257 shaped and sized to receive various handlebars internal to the handlebar clamp 256. A first clamp opening 255 is provided with the first steerer clamp 249 and a second clamp opening 259 is provided with the second steerer clamp 249. The first clamp opening 255 and the second clamp opening 259 may generally be shaped and sized to receive a steerer as described elsewhere herein. For example, the first clamp opening 255 and the second clamp opening 259 may be similarly shaped and sized each to receive a consistent outer dimension of a steerer second portion.

Still referring to FIG. 16A, the first steerer clamp 248 is provided with at least one of a first attachment opening 278. The present example provides a plurality of the first attachment opening 278, each configured for receiving a threaded fastener. The first attachment opening 278 may be variously arranged, but as shown is disposed adjacent to the handlebar clamp 256. In the present example, the attachment openings 278 are provided for ease of access when assembled, for example as shown in FIG. 2A. The second steerer clamp 249 is provided with a second clamp opening 280 to receive a fastener for clamping around the steerer.

FIG. 16B is a top view of the stem 246 of FIG. 16A. As can be seen from FIG. 16B, the first clamp opening 255 and the second clamp opening 259 may generally have a consistent inner dimension for receiving a consistent portion of a steerer.

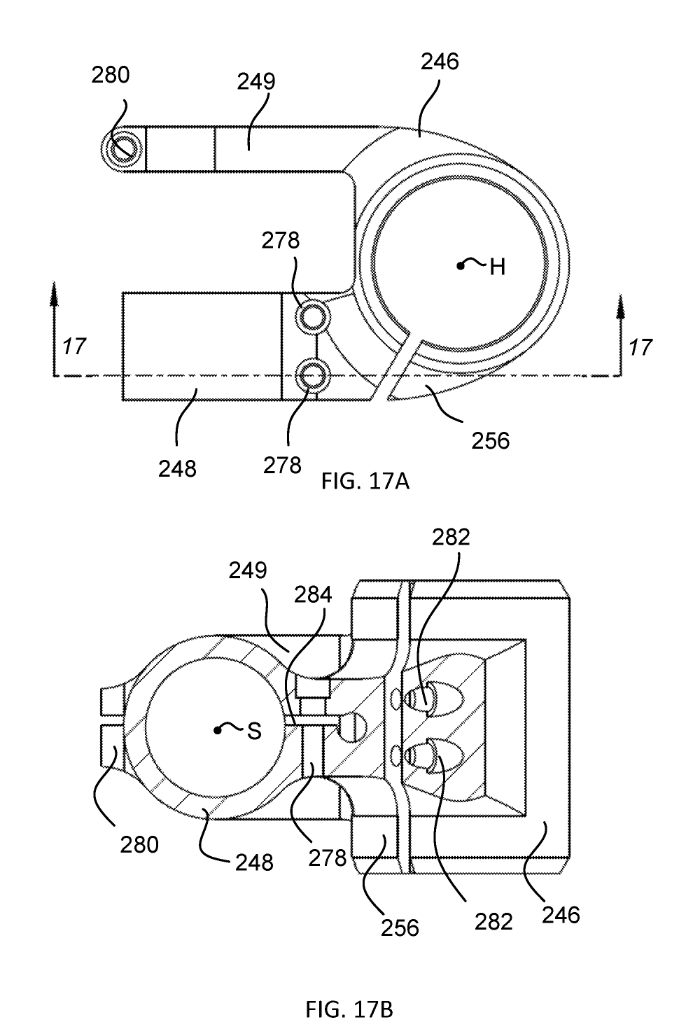

Turning to FIG. 17A, a side view of the stem 246 of FIGS. 16A and 16B is provided. FIG. 17B is a sectional view of the stem 246 taken along line 17-17 in FIG. 17A. As can be seen in FIG. 17B, one or more of a handlebar attachment opening 282 may be provided. For example, the handlebar attachment opening 282 may be configured to facilitate clamping of the stem 246 around a handlebar. The handlebar attachment opening 282 may receive a threaded fastener. The first attachment opening 278 is shown disposed between the steering axis S and the handlebar axis H. The first attachment opening 278 may also be described as disposed between the first steerer clamp 248 and the handlebar clamp 256. As shown in FIG. 17B, the first attachment opening 278 may interact with a deflection clearance 284. For example, the deflection clearance 284 may be controlled by compressing along the first attachment opening 278 with a threaded fastener as described above, with the deflection clearance 284 also disposed between the handlebar axis H and the steering axis S.

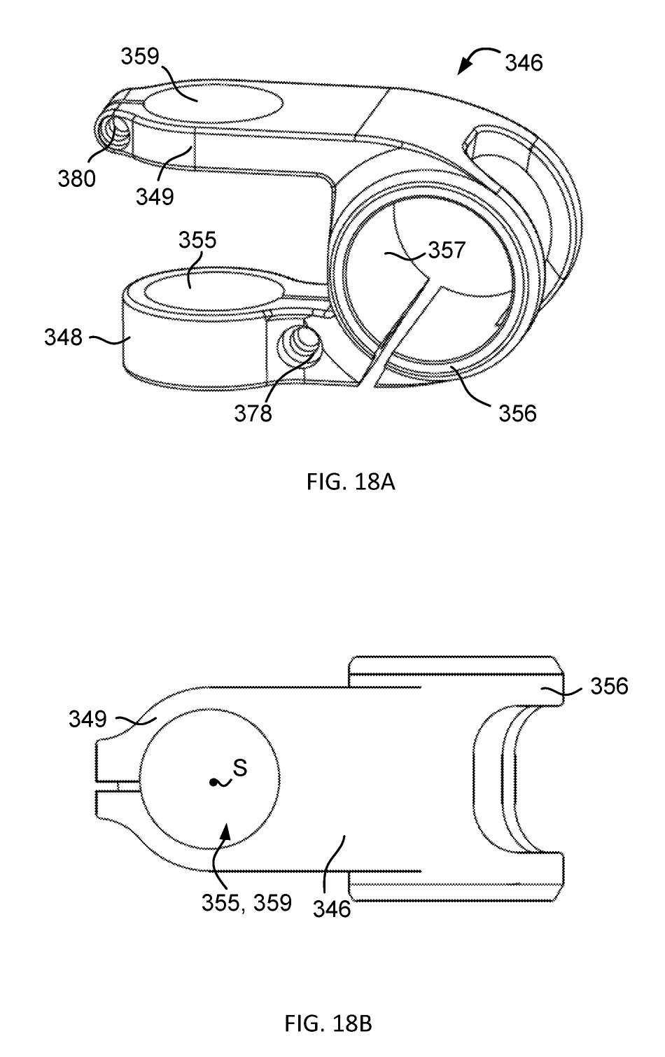

FIG. 18A is a perspective view of the stem 346 that may be used with various bicycles as shown in the sectional views of FIGS. 6 and 7. The stem 346 may generally include features and characteristics like those described with reference to the stem 346 above. For example, the stem 346 includes a first clamp opening 355, a second clamp opening 359, a first attachment opening 378, a second attachment opening 380, a handlebar mounting surface 357, and a handlebar attachment opening 382. As shown in the example of FIG. 18A, a single first attachment opening 378 may be provided, for example to allow for vertical adjustment of the stem 346 as shown between FIGS. 6 and 7 above.

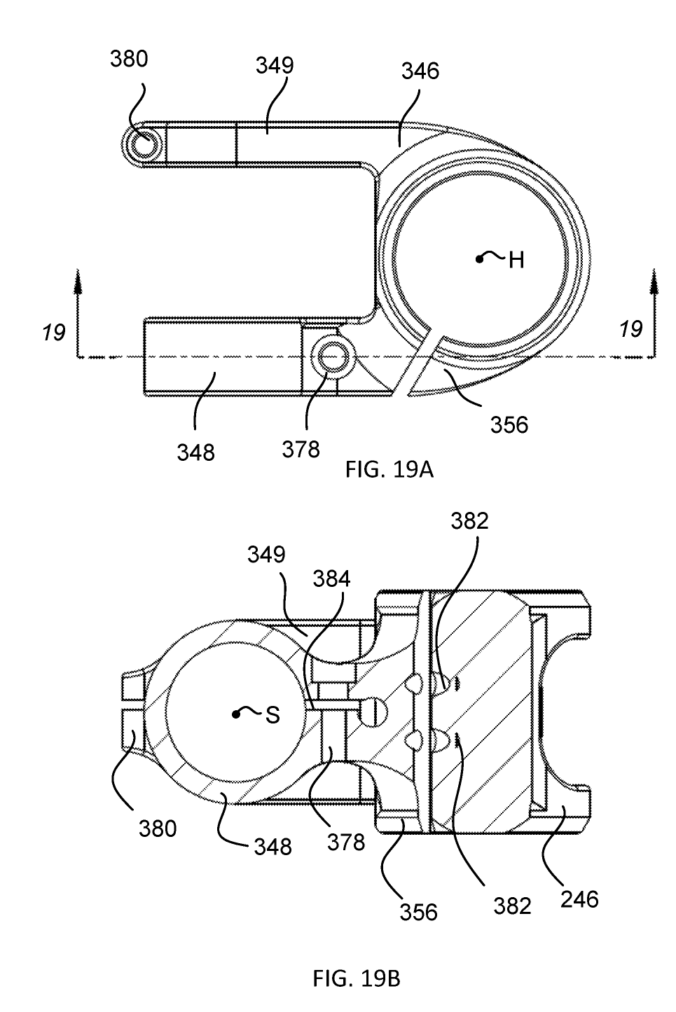

FIG. 18B is a top view of the stem 346 of FIG. 18A. FIG. 19A is a side view of the stem 346 of FIG. 18A. FIG. 19B is a sectional view of the stem 346, taken along line 19-19 in FIG. 19A. As shown in FIG. 19B, the stem 346 may also include a deflection clearance 384 extending into the first steerer clamp 348 between the steering axis S and the handlebar axis H.

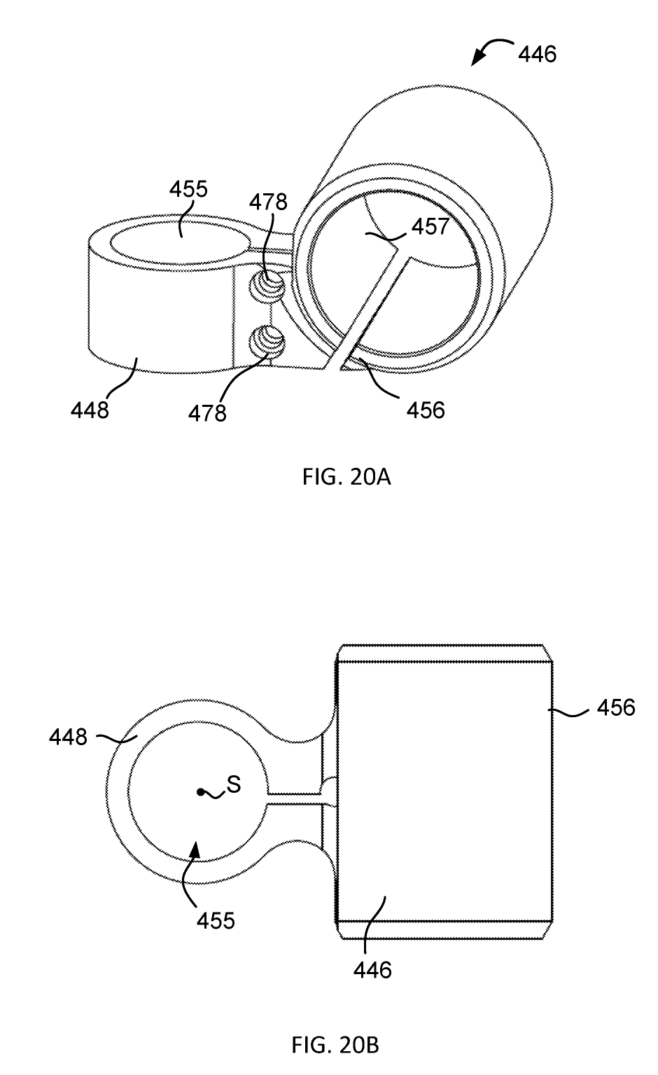

FIG. 20A is a perspective view of the stem 446 that may be used with various bicycles as shown in the sectional view of FIG. 8. The stem 446 as shown includes only the single steerer clamp 448 as described above. The stem 446 may otherwise include similar features and characteristics as the stems described elsewhere herein. For example, the stem 446 may include a handlebar mounting surface 457, a first clamp opening 455, a handlebar attachment opening 482, and a first attachment opening 478.

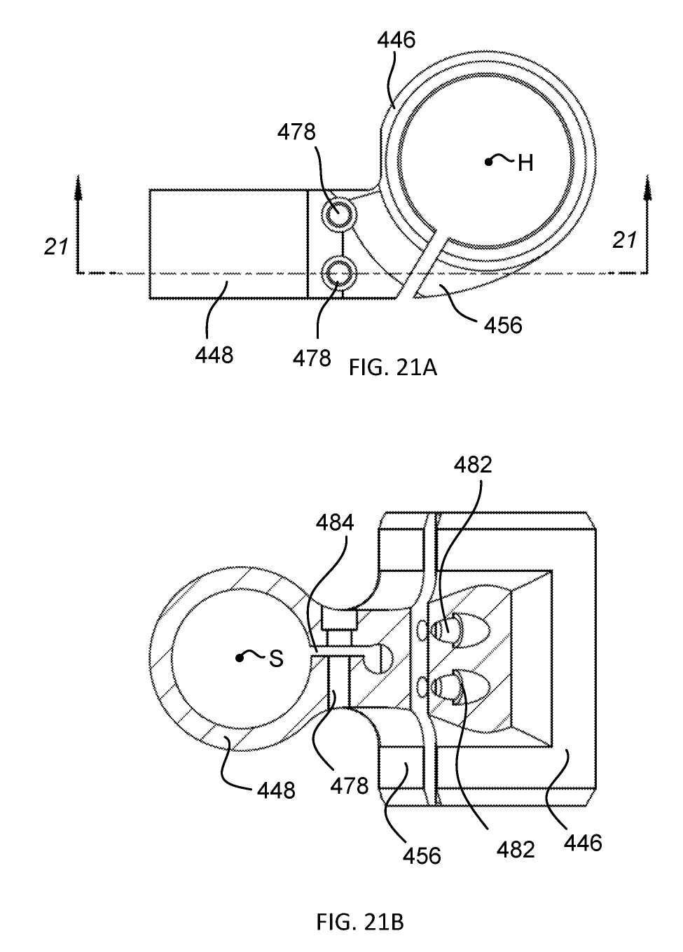

FIG. 20B is a top view of the stem 446 of FIG. 20A. FIG. 21A is a side view of the stem 446 of FIG. 20A. FIG. 21B is a sectional view of the stem 446, taken along line 21-21 in FIG. 21A. As shown in FIG. 21B, a deflection clearance 484 may also be provided between the single steerer clamp 448 and the handlebar clamp 456.

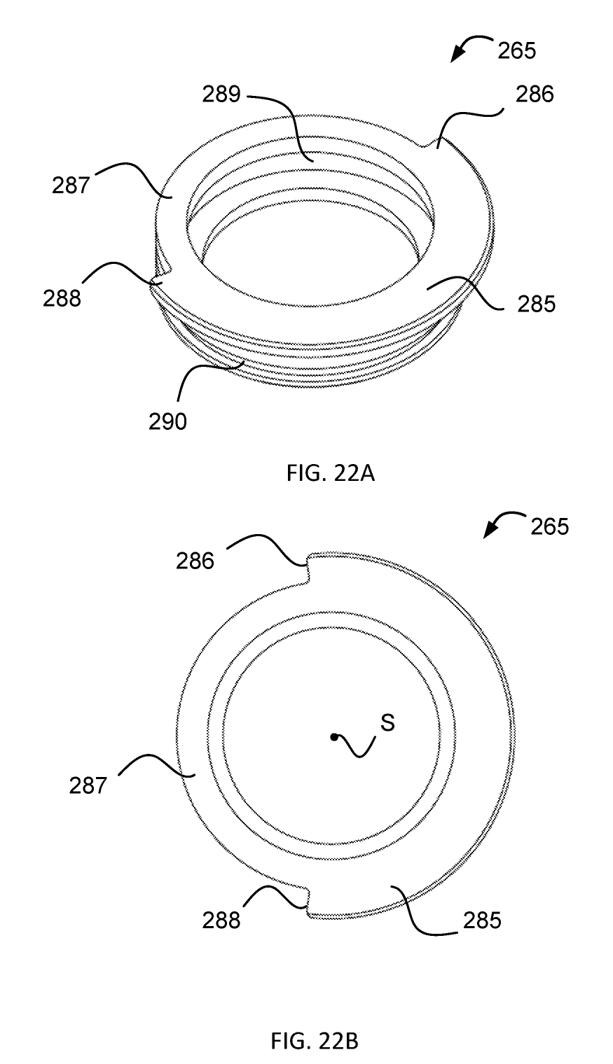

Turning now to FIG. 22A, a perspective view of the shield element 265 as shown in the exploded view of FIG. 11 is provided. The shield element 265 may generally be configured for sealing, rotational control, and other purposes. As shown, the shield element 265 includes an internal gland 289 sized and shaped for retaining at least one sealing feature. For example, the internal gland 289 may be operable to receive a lip seal element such as the inner seal 266 described with reference to FIG. 11 above. At least one external seal gland may be provided, for example a first external gland 290 as shown in FIG. 22A. The first external gland 290 may be configured to retain various seal elements such as the first outer seal 268 of FIG. 11.

Still referring to FIG. 22A, the shield element 265 includes a shield protrusion 285. The shield protrusion 285 is sized and shaped to overhang at least one other element, for example the lower head tube 250 described above. The shield protrusion 285 may accordingly aid to provide protection against ingress into an interior of a bicycle frame. The shield element 265 further includes a first stop surface 286 and a second stop surface 288. The first stop surface 286 and the second stop surface 288 may be integrated with the shield protrusion 285 or may be separately provided. As will be described in greater detail below, the first stop surface 286 and/or the second stop surface 288 may optionally be provided to aid in alignment during installation or to aid in rotational control or limitation of a steering device.

FIG. 22B is a top view of the shield element 265 of FIG. 22A. As shown in FIG. 22B, a shield body 287 may provide an upper surface of the shield element 265. The shield body 287 may include the shield protrusion 285. It should be appreciated that some examples may not include the shield protrusion 285 but retain the shield body 287, for example to allow greater rotational freedom but limit ingress past the shield element 265.

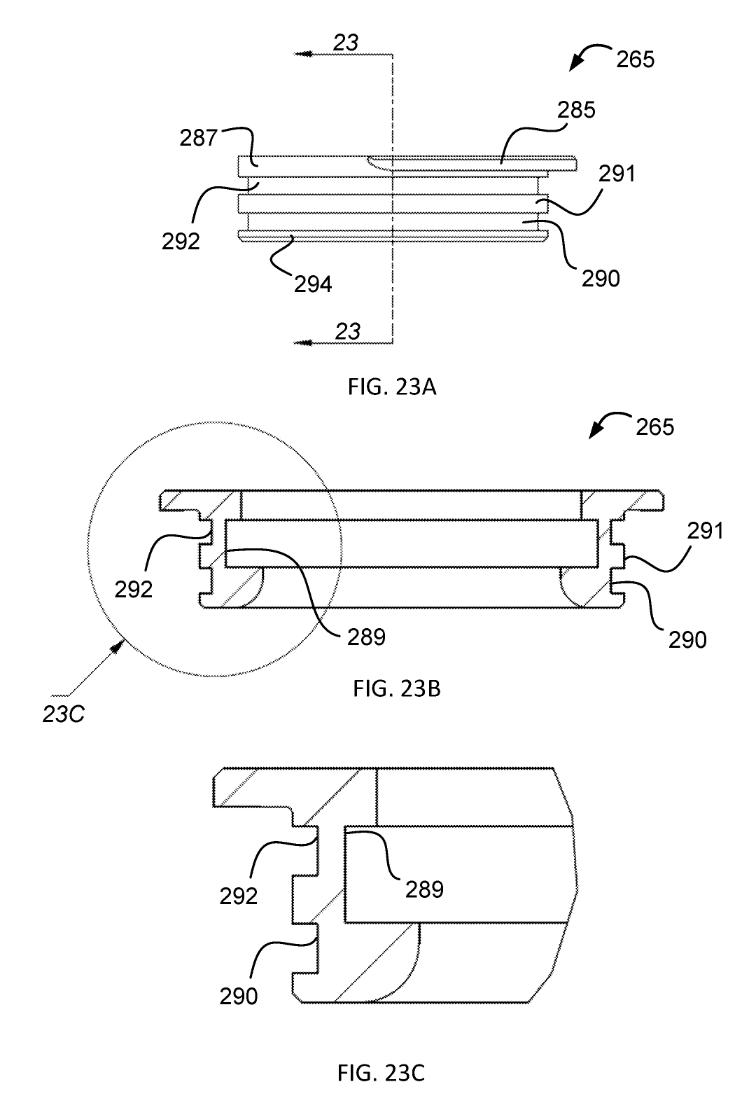

Turning now to FIG. 23A, a side view of the shield element 265 of FIG. 22A is provided. As shown in FIG. 23A, a second external gland 292 may be provided, for example to retain the second outer seal 270 described above with reference to FIG. 11. FIG. 22A further provides a gland spacing 291 disposed between the first external gland 290 and the second external gland 292. The gland spacing 291 may serve to provide more thorough sealing and/or to add stability to insertion of the shield element 265 into a bicycle frame. A shield taper 294 may be provided near a lower end of the shield element 265, for example to aid in installation.

FIG. 23B is a sectional view of the shield element 265, taken along line 23-23 in FIG. 23A. As shown in FIG. 23B, the shield element 265 may serve to rigidly separate at least one internal seal from at least one external seal. For example, the shield element 265 may serve to separate the inner seal 266 housed in the internal gland 289 from the first outer seal 268 housed in the first external gland 290 and/or the second outer seal 270 housed in the second external gland 292. FIG. 23C is an enlarged view of the sectional view of FIG. 23B, showing further details of this exemplary arrangement.

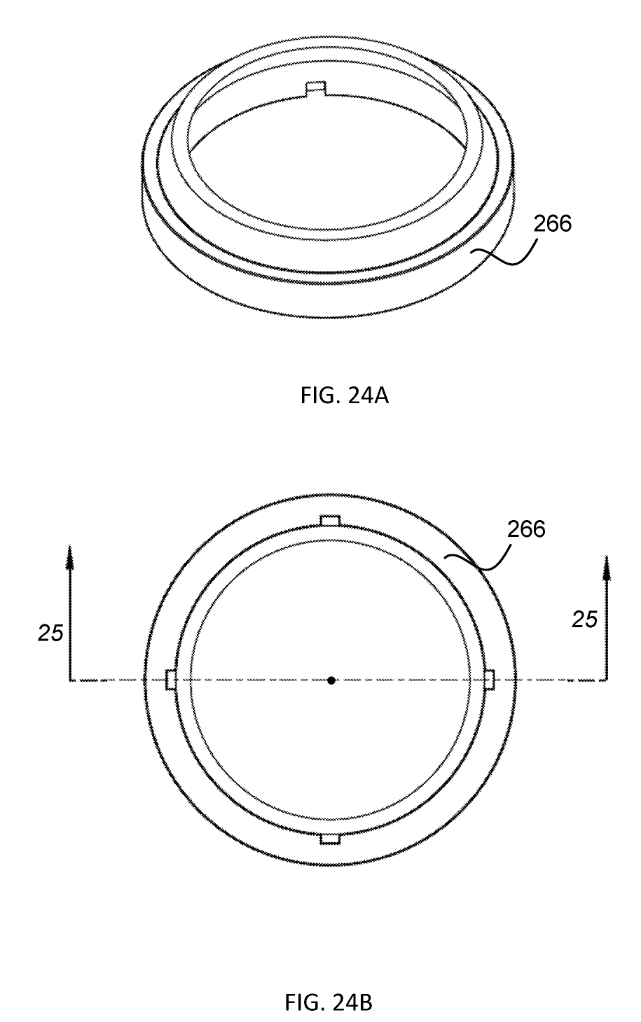

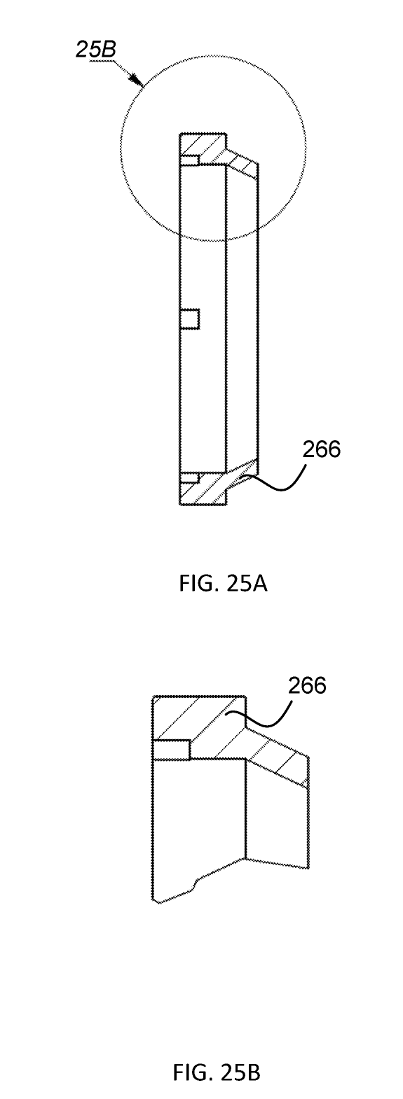

Turning now to FIG. 24A, a perspective view of the inner seal 266 as shown in the exploded view of FIG. 11 is provided. FIG. 24B is a top view of the inner seal 266 of FIG. 24A. FIG. 25A is a sectional view of the inner seal 266 of FIG. 24A, taken along line 25-25 in FIG. 24B. FIG. 25B is an enlarged view of the sectional view of FIG. 25A. As can be seen in FIGS. 24A-25B, the inner seal 266 may generally be configured as a single lip seal. For example, the inner seal 266 may be shaped and sized to be securely retained in the internal gland 289 described above with reference to the shield element 265 while extending into a lip for sealing against a steerer such as the steerer 229. The inner seal 266 may be made of a unitary construction and formed of a rubber such as a butyl or nitrile rubber or a synthetic material. The inner seal 266 may also be overmolded, including rigid and flexible layers.

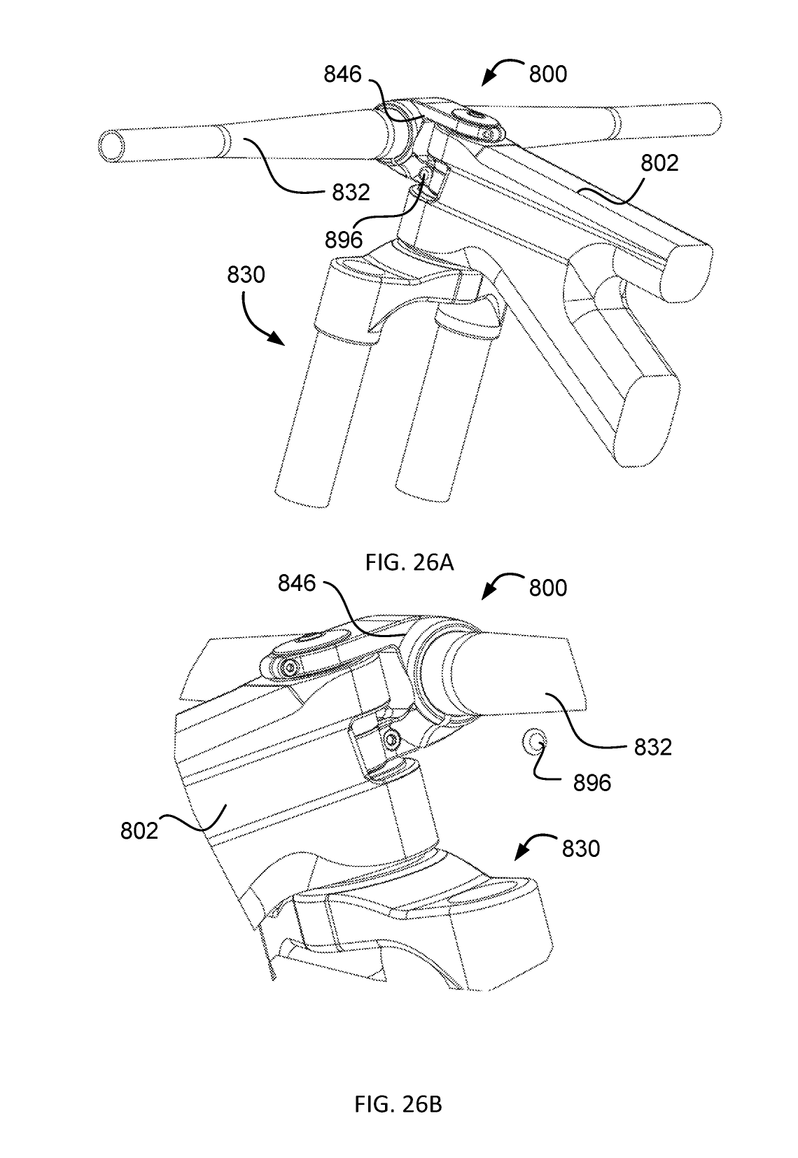

Turning now to FIG. 26A, a perspective view of a steering device 800 mounted to a frame 802 is provided. FIG. 26B is a reversed perspective view of the steering device 800 of FIG. 26A. The steering device 800 and the frame 802 may generally include features and characteristics as described elsewhere herein. As shown in FIG. 26A, the steering device 800 may include at least one rotational stop 896. The rotational stop 896 is provided to at least in part control rotation of a stem 846 relative to the frame 802 when installed. The rotational stop 896 may serve to ensure that overrotation of a handlebar 832 and/or a front fork 830 relative to the frame 802 does not occur. For example, the rotational stop 896 may serve to prevent direct or uncontrolled impingement of the handlebar 832 and the frame 802 and/or the front fork 830 and the frame 802.

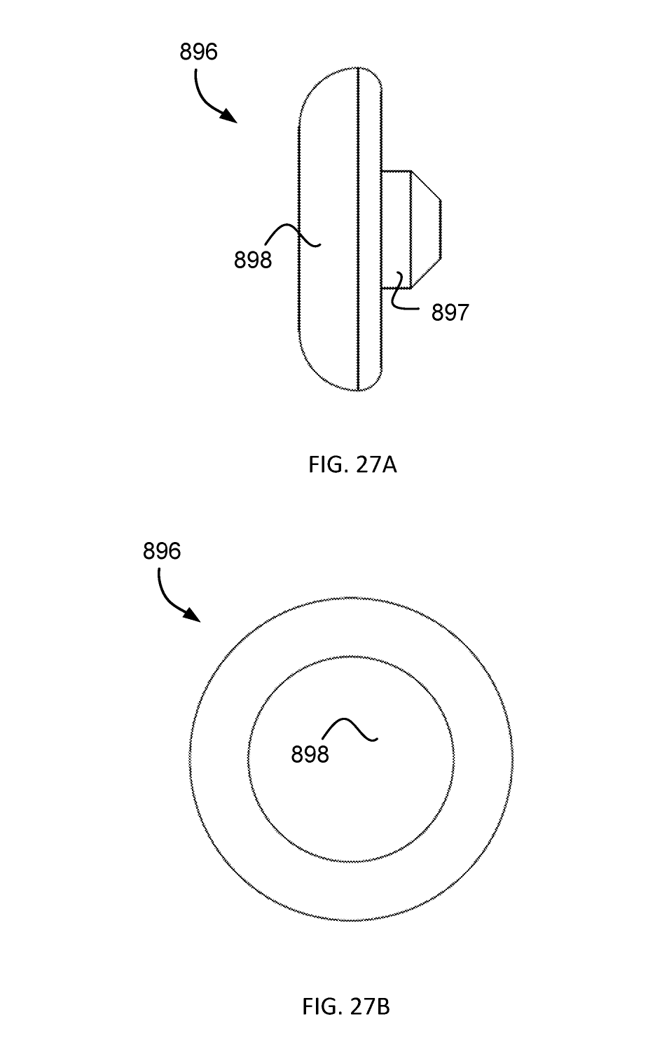

Turning now to FIG. 27A, a side view of the rotational stop 896 is shown. FIG. 27B is a front view of the rotational stop 896. As shown, the rotational stop 896 may be sized and shaped to insert into a fastener, for example a hex head or star head or similar fastener. The rotational stop 896 may have an insertion portion 897 and a stop portion 898. The insertion portion 897 may be sized and shaped to friction fit within a fastener head or other element associated with the steering device 800. The stop portion 898 may be sized and shaped to interface with a portion of the frame 802 or another element fixed relative to the frame 802. In an example, the stop portion 898 is configured to interface with the frame in between the upper head tube 251 and the lower head tube 250 (see, e.g. FIG. 2A).

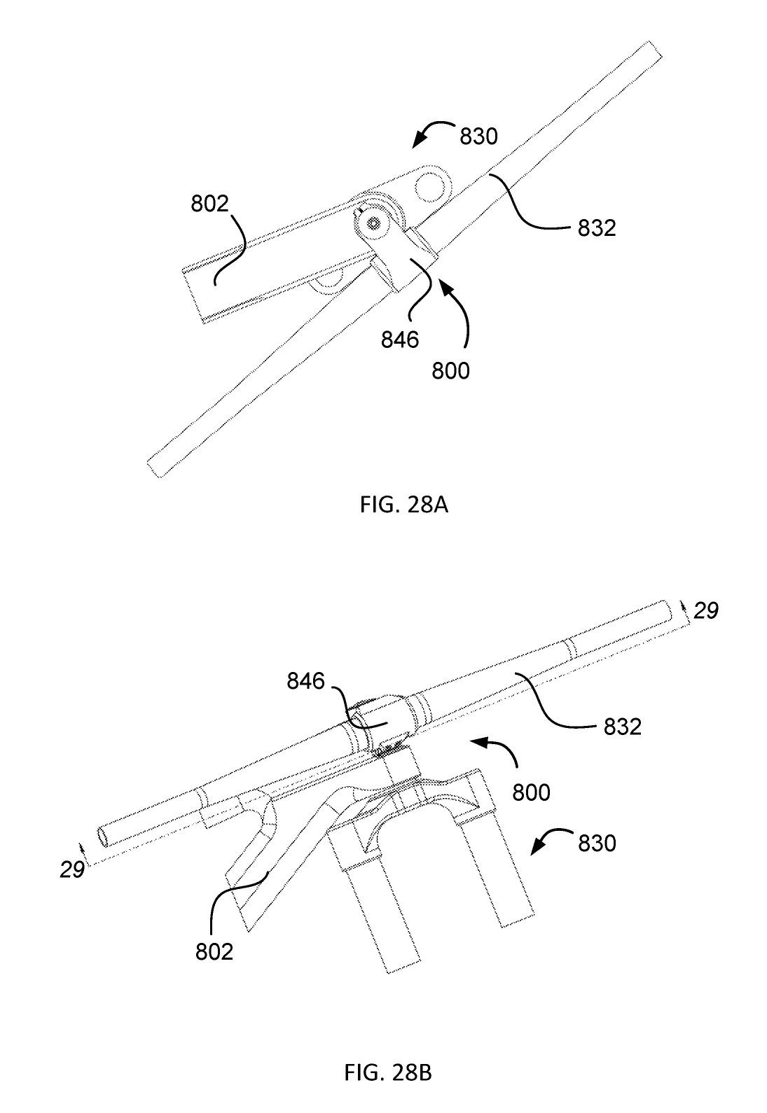

FIG. 28A is a top view of the steering device 800 in a stop position. FIG. 28B is a front perspective view of the steering device 800 in the stop position of FIG. 28A. As shown in the stop position, the steering device 800 is at a maximum steering angle, pictured as a maximum rightward steering angle. The maximum steering angle as described in this example is determined by the rotational stop 896 described above.

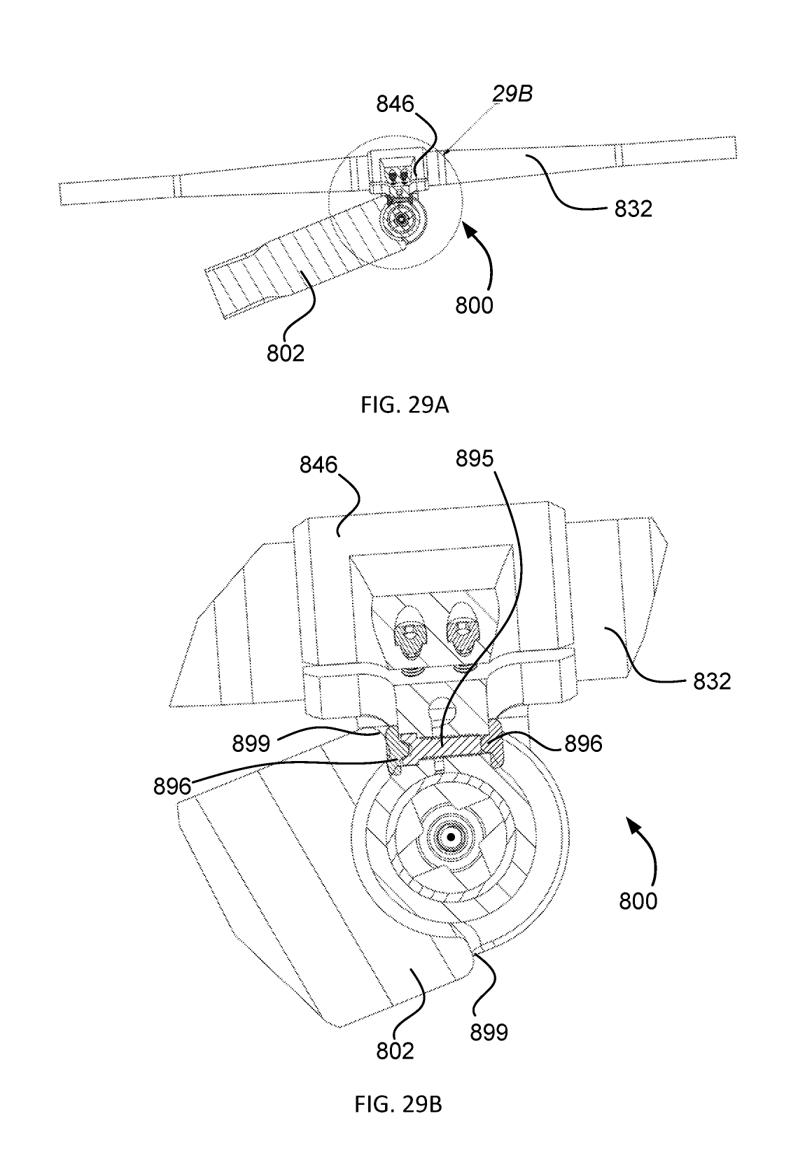

FIG. 29A is a sectional view of the steering device 800, taken along line 29-29 in FIG. 28B. FIG. 29B is an enlarged view of the sectional view of FIG. 29A. As shown in this example, the rotational stop 896 provided on a first or left side of the stem 849 interfaces with a stem fastener 895 and the rotational stop 896 provided on a second or right side of the stem 849 interfaces with an attachment opening for the fastener, for example the first attachment opening 278 described above. As shown in FIG. 29B, the rotational stop 896 is shaped and sized to impinge on a complimentary stop surface 899. In the present example, the complimentary stop surface 899 is provided integrally with the frame 802. However, it should be appreciated that a separate stop surface 899 may be provided with the steering device 800.

The steering device 800 may generally be configured to limit rotational movement, for example with the rotational stop(s) 896 described above, to a defined range. The rotational range of movement allowed may be determined by clearance between the frame 802 and the handlebar 832 and/or the front fork 830. In an example, the rotational range of movement may be at least 60 degrees off center or 120 degrees total. In other examples, the rotational range of movement may be controlled by the rotational stop(s) 896 to be at least 70 degrees, 72 degrees, 75 degrees, or 78 degrees off center.

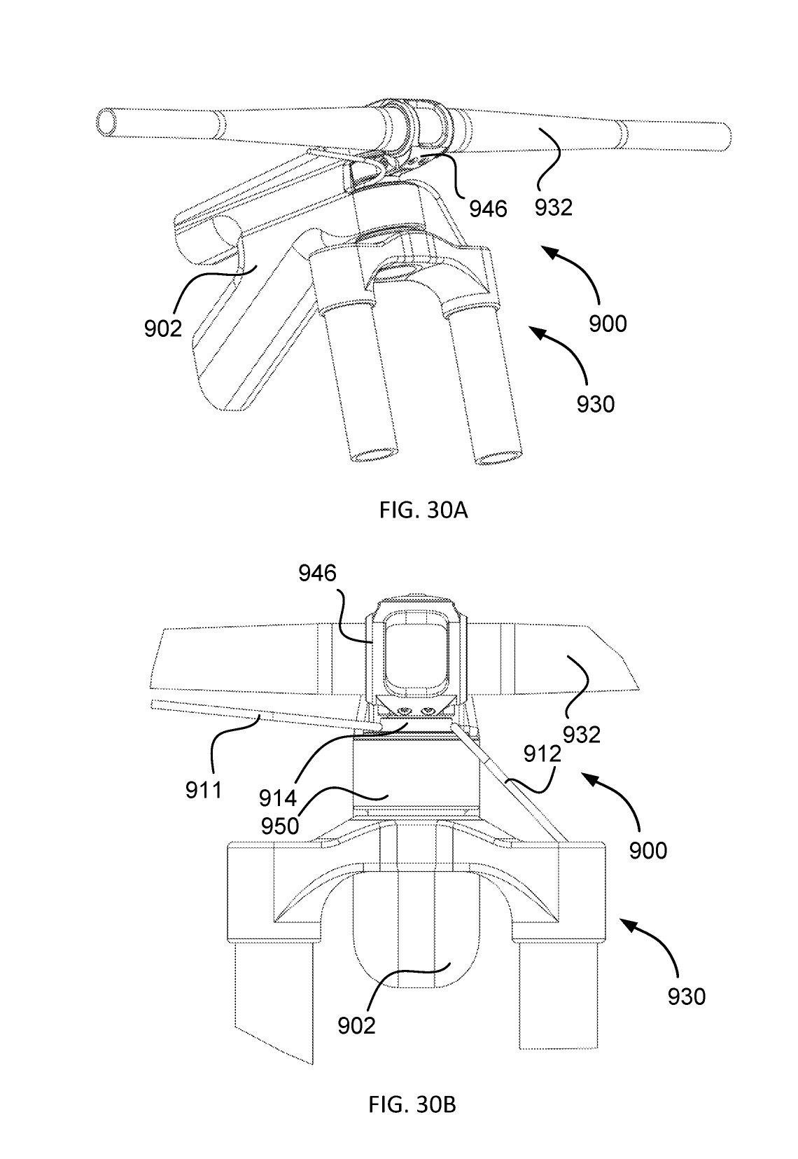

Turning now to FIG. 30A, a perspective view of a steering device 900 mounted to a frame 902 is provided. FIG. 30B is a front view of the steering device 900 of FIG. 30A. The steering device 900 may generally include features and characteristics of other examples described herein, for example a front fork 930, a stem 946, and a handlebar 932. As shown in FIG. 30B, at least one control connection, such as a cable, hose, or electrical conductor, may be provided controlled entry into the frame 902 through the steering device 900. In the present example, a first control connection 911 and a second control connection 912 are provided entry above a lower head tube 950. A guide element 914 is provided with the steering device 900.

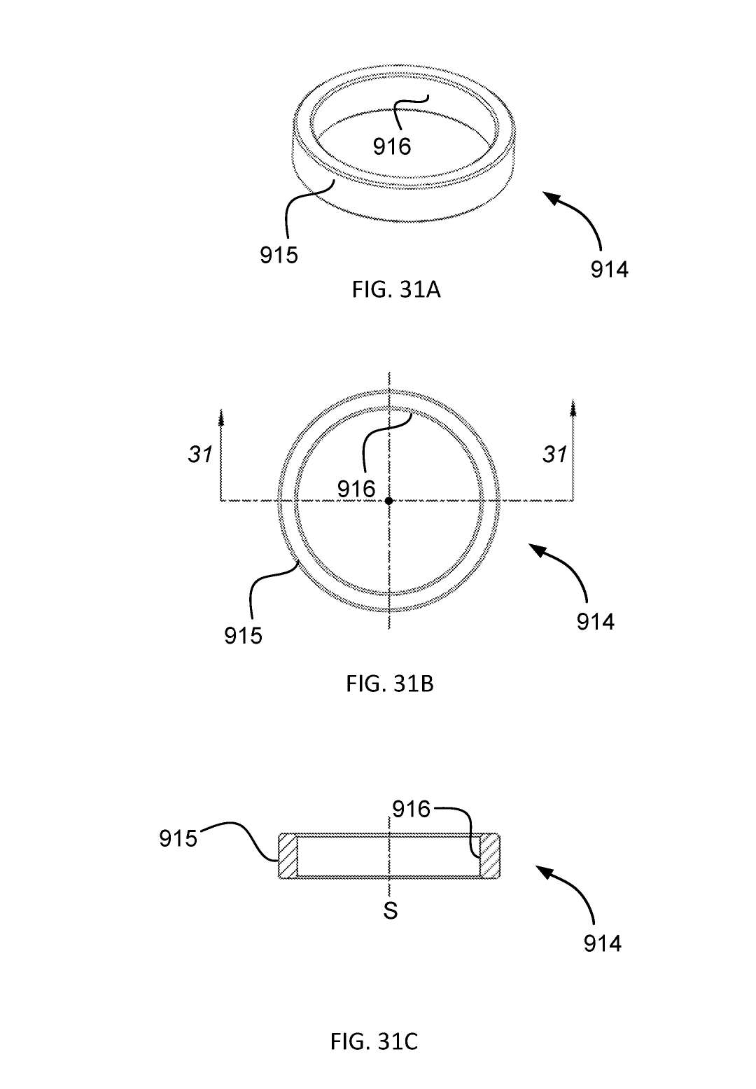

FIG. 31A is a perspective view of the guide element 914 that may be used with any example steerer device described herein. FIG. 31B is a top view of the guide element 914 of FIG. 31A. FIG. 31C is a sectional view of the guide element 914 of FIG. 31A, taken along line 31-31 in FIG. 31B. The guide element 914 may generally be configured to guide one or more control connections, such as the first control connection 911 and/or the second control connection 912. The guide element 914 is shaped and sized to fit around a steerer, such as the steerer 229 described above. For example, the guide element 914 may have a guide element inner surface 916 sized to fit over a steerer. The guide element 914 may further include a guide element outer surface 915 to guide one or more control connections. The guide element 914 may serve in part to protect a steerer or other component from wear or abrasion from one or more control connections.

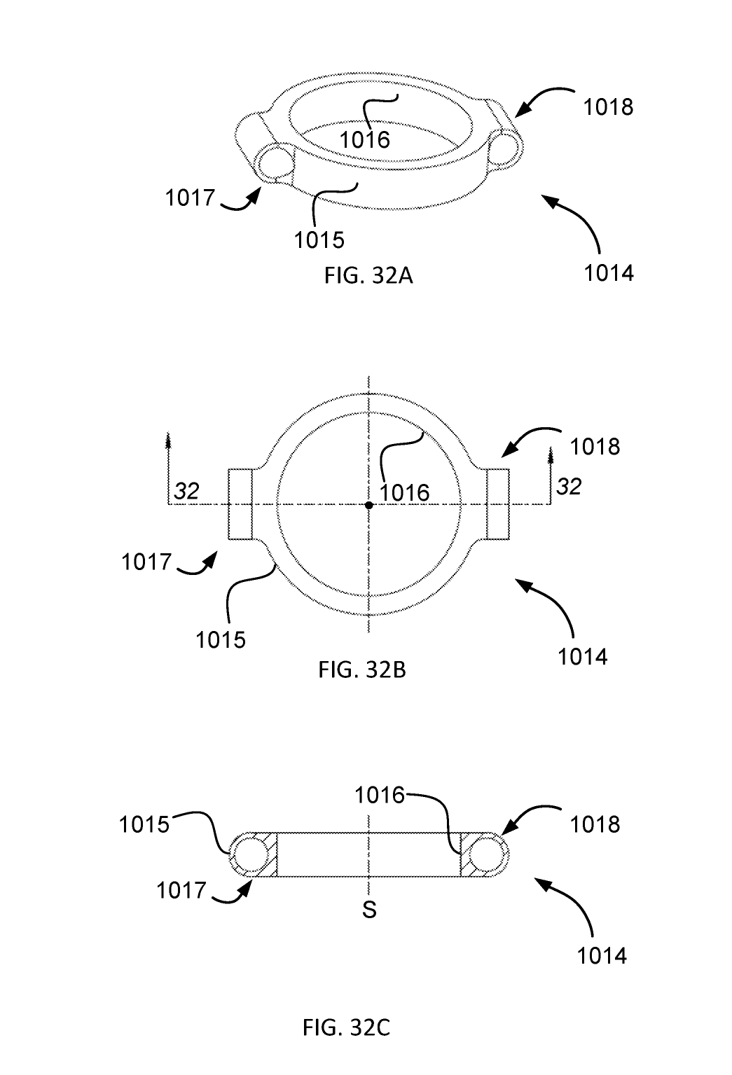

FIG. 32A is a perspective view of a guide element 1014 that may be used with an example steerer device. FIG. 32B is a top view of the guide element 1014 of FIG. 32A. FIG. 32C is a sectional view of the guide element 1014 of FIG. 32A, taken along line 32-32 in FIG. 32B. The guide element 1014 may be generally configured as the guide element 914 described above, for example including a guide element inner surface 1016 opposite a guide element outer surface 1015. The guide element 1014 of the present example further includes a first guide 1017 and a second guide 1018. The first guide 1017 and/or the second guide 1018 may be configured to guide one or more control connections, such as cables, hoses, or electrical connections. As shown in the present example, the first guide 1017 and/or the second guide 1018 may be of a closed configuration to retain control connections securely.

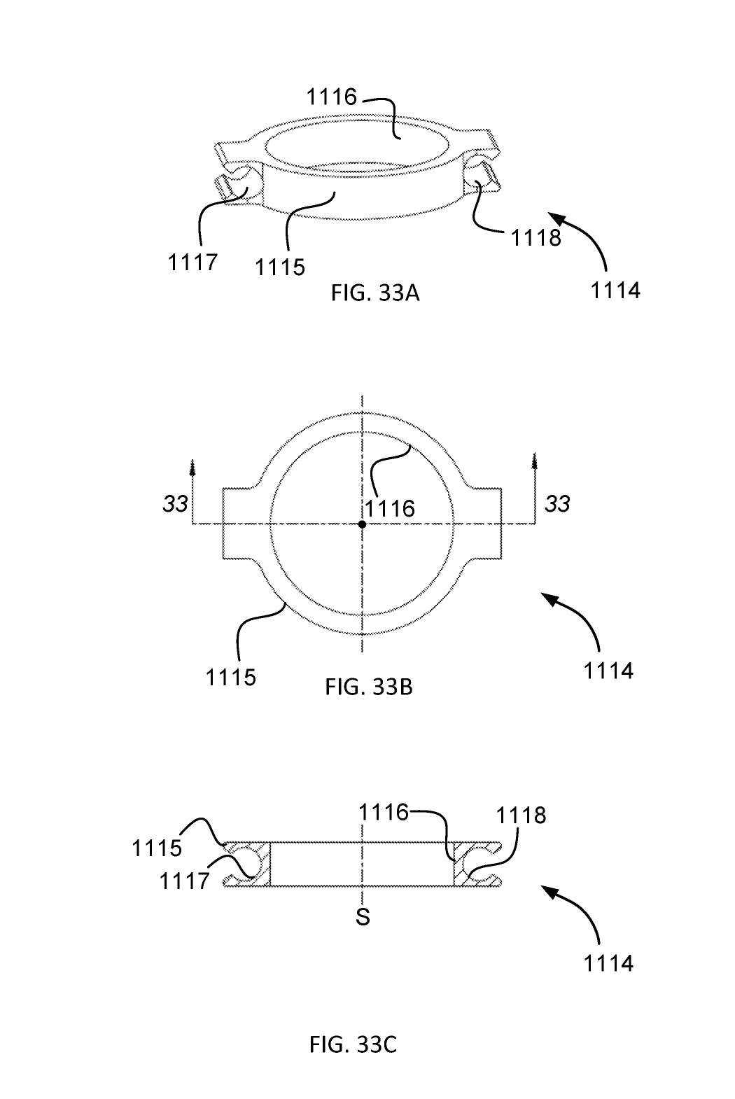

Turning now to FIG. 33A, a perspective view of a guide element 1114 that may be used with an example steerer device is provided. FIG. 33B is a top view of the guide element 1114 of FIG. 33A. FIG. 33C is a sectional view of the guide element 1114 of FIG. 33A, taken along line 33-33 in FIG. 33B. In the present example, the guide element 1114 may be configured similarly to previous examples, for example including a guide element inner surface 1116 opposite a guide element outer surface 1115, a first guide 1117 and a second guide 1118. As shown in the present example, the first guide 1117 and the second guide 1118 are of an open configuration, for example to allow routing of control connections without disassembly but instead with a side-entry friction fit.

The embodiments described herein may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Further aspects are provided by the subject matter of the following clauses:

A steering device for a bicycle, the steering device comprising: a stem for attachment between a handlebar and a steerer, the stem comprising: a first steerer clamp for attachment to the steerer between a first bearing and a second bearing; a second steerer clamp for attachment to the steerer above the first bearing and the second bearing; and a handlebar clamp for attachment to the handlebar.

The steering device of the preceding clause, wherein the first steerer clamp includes a first inner diameter and the second steerer clamp includes a second inner diameter, wherein the first inner diameter is greater than the second inner diameter.

The steering device of any one of the preceding clauses, wherein the first inner diameter of the first steerer clamp is a tapered inner diameter.

The steering device of any one of the preceding clauses, wherein the first inner diameter of the first steerer clamp is a straight inner diameter.

The steering device of any one of the preceding clauses, wherein the first steerer clamp includes a first inner diameter and the second steerer clamp includes a second inner diameter, wherein the first inner diameter is the same as the second inner diameter.

The steering device of any one of the preceding clauses, further comprising a sealing arrangement for attachment to the steerer between the lower bearing and the first steerer clamp.

The steering device of any one of the preceding clauses, further comprising a guide element comprising a guide element inner surface sized to fit over the steerer and a guide element outer surface to guide one or more control connections.

The steering device of any one of the preceding clauses, wherein the guide element further comprises at least one guide to retain at least one of the one or more control connections.

The steering device of any one of the preceding clauses, further comprising at least one rotational stop disposed on a side of the stem and sized and shaped to impinge on a complimentary stop surface on a head tube of the bicycle.

The steering device of any one of the preceding clauses, further comprising a preload device to add axial load to the first bearing and the second bearing through the second steerer clamp.

The steering device of any one of the preceding clauses, further comprising a preload spacer repositionable above or below the second steerer clamp, the preload spacer to transmit preload force between the preload device and the first bearing.

The steering device of any one of the preceding clauses, further comprising a shield element disposed between the first bearing and the second bearing, the shield element provided to locate an inner seal against the steerer and an outer seal against a frame of the bicycle.

The steering device of any one of the preceding clauses, wherein the shield element comprises a shield protrusion shaped and sized to overhang a lower head tube of the frame of the bicycle

A steering device for a bicycle, the steering device comprising: a stem attachable to a steerer between an upper bearing and a lower bearing of a headset; and a sealing arrangement for attachment to the steerer spaced apart between the lower bearing and the upper bearing.

The steering device of any one of the preceding clauses, wherein the stem comprises a steerer clamp for attachment to the steerer between the upper bearing and the lower bearing of the headset, wherein the sealing arrangement is for attachment to the steerer between the lower bearing of the headset and the steerer clamp.

The steering device of any one of the preceding clauses, wherein the sealing arrangement includes an internal seal and an external seal disposed on opposite sides of a shield element disposed around the steerer.

The steering device of any one of the preceding clauses, wherein the shield element comprises a shield protrusion to protect against ingress into an interior of a frame of the bicycle.

The steering device of any one of the preceding clauses, wherein the stem comprises: a lower steerer clamp for attachment to the steerer between the lower bearing and a upper bearing; an upper steerer clamp for attachment to the steerer above the lower bearing and the upper bearing; and a handlebar clamp for attachment to a handlebar.

A steering device for a bicycle, the steering device comprising: a steerer for attachment between a crown and a stem, the steerer comprising: a first portion having a first length and a first outer diameter for attachment of a lower bearing; a second portion having a second outer diameter for attachment of the stem, the second outer diameter being smaller than the first outer diameter; a transition portion disposed between the first portion and the second portion, the transition portion having a transition length, wherein the transition length is less than the first length.

The steering device of any one of the preceding clauses, wherein the first portion includes a crown overlap portion wherein the steerer overlaps the crown.

The steering device of any one of the preceding clauses, wherein the steerer and the crown are unitary, with the first portion of the steerer beginning immediately above the crown.

The steering device of any of the preceding clauses, wherein the first portion includes a crown overlap portion wherein the steerer overlaps the crown.

The steering device of any of the preceding clauses, wherein the steerer and the crown are unitary, with the first portion of the steerer beginning immediately above the crown.

A steering device as generally described and shown herein.

We claim:

1. A steering device for a bicycle, the steering device comprising:
a stem for attachment between a handlebar and a steerer, the stem comprising:
a first steerer clamp for attachment to the steerer between a first bearing and a second bearing;
a second steerer clamp for attachment to the steerer above the first bearing and the second bearing; and
a handlebar clamp for attachment to the handlebar.

2. The steering device of claim 1, wherein the first steerer clamp includes a first inner diameter and the second steerer clamp includes a second inner diameter, wherein the first inner diameter is greater than the second inner diameter.

3. The steering device of claim 2, wherein the first inner diameter of the first steerer clamp is a tapered inner diameter.

4. The steering device of claim 1, wherein the first steerer clamp includes a first inner diameter and the second steerer clamp includes a second inner diameter, wherein the first inner diameter is the same as the second inner diameter.

5. The steering device of claim 1, further comprising a sealing arrangement for attachment to the steerer between the lower bearing and the first steerer clamp.

6. The steering device of claim 1, further comprising a guide element comprising a guide element inner surface sized to fit over the steerer and a guide element outer surface to guide one or more control connections.

7. The steering device of claim 6, wherein the guide element further comprises at least one guide to retain at least one of the one or more control connections.

8. The steering device of claim 1, further comprising at least one rotational stop disposed on a side of the stem and sized and shaped to impinge on a complimentary stop surface on a head tube of the bicycle.

9. The steering device of claim 1, further comprising a preload device to add axial load to the first bearing and the second bearing through the second steerer clamp.

10. The steering device of claim 9, further comprising a preload spacer repositionable above or below the second steerer clamp, the preload spacer to transmit preload force between the preload device and the first bearing.

11. The steering device of claim 1, further comprising a shield element disposed between the first bearing and the second bearing, the shield element provided to locate an inner seal against the steerer and an outer seal against a frame of the bicycle.

12. The steering device of claim 11, wherein the shield element comprises a shield protrusion shaped and sized to overhang a lower head tube of the frame of the bicycle.

13. A steering device for a bicycle, the steering device comprising:
a stem attachable to a steerer between an upper bearing and a lower bearing of a headset; and
a sealing arrangement for attachment to the steerer between the lower bearing and the upper bearing.

14. The steering device of claim 13, wherein the stem comprises a steerer clamp for attachment to the steerer between the upper bearing and the lower bearing of the headset, wherein the sealing arrangement is for attachment to the steerer between the lower bearing of the headset and the steerer clamp.

15. The steering device of claim 13, wherein the sealing arrangement includes an internal seal and an external seal disposed on opposite sides of a shield element disposed around the steerer.

16. The steering device of claim 15, wherein the shield element comprises a shield protrusion to protect against ingress into an interior of a frame of the bicycle.

17. The steering device of claim 13, wherein the stem comprises:
a lower steerer clamp for attachment to the steerer between the lower bearing and a upper bearing;
an upper steerer clamp for attachment to the steerer above the lower bearing and the upper bearing; and
a handlebar clamp for attachment to a handlebar.

18. A steering device for a bicycle, the steering device comprising:
a steerer for attachment between a crown and a stem, the steerer comprising:
a first portion having a first length and a first outer diameter for attachment of a lower bearing;
a second portion having a second outer diameter for attachment of the stem, the second outer diameter being smaller than the first outer diameter; and
a transition portion disposed between the first portion and the second portion, the transition portion having a transition length, wherein the transition length is less than the first length.

19. The steering device of claim 18, wherein the first portion includes a crown overlap portion wherein the steerer overlaps the crown.

20. The steering device of claim 18, wherein the steerer and the crown are unitary, with the first portion of the steerer beginning immediately above the crown.
